(19) United States
(12) Patent Application Publication
(10) Pub. No.: US 2025/0384758 A1
(43) Pub. Date: Dec. 18, 2025

(54) OBJECT RECOGNITION AND REMINDER SYSTEM

(71) Applicant: Volvo Car Corporation, Göteborg (SE)

(72) Inventors: Per Tengstrand, Göteborg (SE); Mehmet Mehmetalioglu, Göteborg (SE); Jessica Zanatta, Göteborg (SE); Manu Revi, Göteborg (SE)

(73) Assignee: Volvo Car Corporation, Göteborg (SE)

(21) Appl. No.: 18/740,676

(22) Filed: Jun. 12, 2024

(51) Int. Cl. G08B 21/24; G06V 10/764; G06V 20/59; G06V 40/16

(52) U.S. Cl. CPC G08B 21/24; G06V 10/764; G06V 20/597; G06V 40/172

(57) ABSTRACT

According to an embodiment, disclosed is a system comprising one or more sensors; and a processor storing instructions in a memory that, when executed, cause the processor to identify, a user from one or more users of a vehicle, based on a user profile comprising a user identification detail; detect, a presence of one or more objects within the vehicle; monitor, the objects and the user using data from the sensors; generate, a first message based on a continued presence of the objects after an exit location of the user based on an image analysis of a first image and a second image of a portion of an interior region of the vehicle; and transmit, the first message to a user device; and wherein the system is configured for dynamic tracking of the objects and reminding via an alert notification.

### FIELD OF THE INVENTION

The technical field generally relates to object detection systems, and more particularly relates to methods and systems for detecting objects that are forgotten in a vehicle and providing a reminder via an alert notification to the user.

### BACKGROUND

The problem of forgetting objects in the vehicle has probably been around for as long as there have been vehicles. However, there are no known solutions to alerting an individual user about personal objects left behind.

Therefore, there is a need for a system and a method for determining that a personal object is forgotten in the vehicle that belongs to the user and notifying the user.

### SUMMARY

The following presents a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

According to an embodiment, disclosed is a system comprising one or more sensors, and a processor storing instructions in a memory that, when executed, cause the processor to identify, a user from one or more users of a vehicle, based on a user profile of the user, wherein the user profile comprises a user identification detail; detect, via the sensors, a presence of one or more objects within the vehicle; monitor, the objects and the user within the vehicle using data from the sensors; generate, a first message based on a continued presence of the objects after an exit location of the user based on an image analysis of a first image and a second image of a portion of an interior region of the vehicle; and transmit the first message to a user device; and wherein the system is configured for dynamic tracking the objects within the vehicle and providing an alert notification.

According to an embodiment, disclosed is a method comprising identifying, a user from one or more users of a vehicle based on a user profile of the user, wherein the user profile comprises a user identification detail; detecting, via one or more sensors, a presence of one or more objects within the vehicle; monitoring, the objects and the user within the vehicle using data from the sensors; generating a first message based on a continued presence of the objects after an exit location of the user based on an image analysis of a first image and a second image of a portion of an interior region of the vehicle; and transmitting the first message to a user device; and wherein the method is configured for dynamic tracking the objects within the vehicle and providing an alert notification.

According to an embodiment, disclosed is a non-transitory computer-readable medium having stored thereon instructions executable by a computer system to perform operations comprising: identify, a user from one or more users of a vehicle based on a user profile of the user, wherein the user profile comprises a user identification detail; detecting, via one or more sensors, a presence of one or more objects within the vehicle; monitoring, the objects and the user within the vehicle using data from the sensors; generating a first message based on a continued presence of the objects after an exit location of the user based on an image analysis of a first image and a second image of a portion of an interior region of the vehicle; and transmitting the second message to a user device; and wherein the instructions are configured for dynamic tracking the objects within the vehicle and providing an alert notification.

According to an embodiment, disclosed is a system comprising one or more sensors; and a processor storing instructions in a memory that, when executed, cause the processor to detect, via the sensors, a presence of one or more objects within a vehicle; identify, a user from one or more users of a vehicle based on a user profile of the user, wherein the user profile comprises a user identification detail; monitor the objects and the user within the vehicle using data from the sensors; generate a first message based on a continued presence of the objects after an exit location based on an image analysis of a first image and a second image of a portion of an interior region of the vehicle; and transmit the first message to a user device; and receive, a second message from the user device, wherein the second message comprises one or more of a confirmation by the user that the objects belong to the user.

### BRIEF DESCRIPTION OF THE FIGURES

These and other aspects of the present invention will now be described in more detail, with reference to the appended drawings showing exemplary embodiments of the present invention, in which:

FIG. 1 shows the block diagram of the system for object recognition and reminder generation for a vehicle based on a user profile according to an embodiment.

FIG. 2A is an illustration of a vehicle with various sensors, actuators, and systems according to an embodiment.

FIG. 2B is an illustration of an interior of a vehicle with various sensors arranged strategically according to an embodiment.

FIG. 3 shows a block diagram of electronic components of a vehicle according to an embodiment.

FIG. 4A shows identification of the user when the user is in proximity to the vehicle according to an embodiment.

FIG. 4B shows identification of the user when the user is in the vehicle according to an embodiment.

FIG. 4C shows identification of the user using a personal device or a card according to an embodiment.

FIG. 4D shows identification of the user using a personal device or a card according to an embodiment.

FIG. 4E shows a user profile according to an embodiment.

FIG. 5A shows identifying objects that a user is carrying by external cameras on a vehicle according to an embodiment.

FIG. 5B shows identifying objects that a user is carrying by internal cameras of a vehicle according to an embodiment.

FIG. 5C shows a dynamic tracking of an object according to an embodiment.

FIG. 5D shows a user exiting the system alert system for user near to the vehicle versus far away from the vehicle.

FIG. 5E shows a message on in-vehicle display to alert users to not forget personal objects that have been identified by the vehicle according to an embodiment.

FIG. 5F shows a message about objects left behind in the vehicle sent to the user's personal device according to an embodiment.

FIG. 6 shows the hardware of the system for Object recognition reminder system according to an embodiment.

FIG. 7 shows an example block diagram for an Artificial Intelligence and Machine Learning (AI/ML) model used in object recognition and a reminder system according to an embodiment.

FIG. 8A shows a structure of the neural network/machine learning model with a feedback loop according to an embodiment.

FIG. 8B shows a structure of the neural network/machine learning model with reinforcement learning according to an embodiment.

FIG. 9A shows a block diagram of the method executed by the vehicle for object recognition and the reminder system according to an embodiment.

FIG. 9B shows a block diagram of the system of vehicle for object recognition and reminder system according to an embodiment.

FIG. 9C shows a block diagram of the method executed by the non-transitory computer-readable medium for object recognition and reminder system according to an embodiment.

FIG. 10 shows a block diagram of the system of vehicle for object recognition and reminder system according to an embodiment.

FIG. 11 shows a block diagram of the system of vehicle for object recognition and reminder system according to an embodiment.

FIG. 12 shows the block diagram of the cyber security module in view of the system and server according to an embodiment.

### DETAILED DESCRIPTION

For simplicity and clarity of illustration, the figures illustrate the general manner of construction. The description and figures may omit the descriptions and details of well-known features and techniques to avoid unnecessarily obscuring the present disclosure. The figures exaggerate the dimensions of some of the elements relative to other elements to help improve understanding of embodiments of the present disclosure. The same reference numeral in different figures denotes the same element.

Although the detailed description herein contains many specifics for the purpose of illustration, a person of ordinary skill in the art will appreciate that many variations and alterations to the details are considered to be included herein.

Accordingly, the embodiments herein are without any loss of generality to, and without imposing limitations upon, any claims set forth. The terminology used herein is for the purpose of describing particular embodiments only and is not limiting. Unless defined otherwise, all technical and scientific terms used herein have the same meaning as commonly understood by one with ordinary skill in the art to which this disclosure belongs. The following terms and phrases, unless otherwise indicated, shall be understood to have the following meanings.

As used herein, the articles “a” and “an” used herein refer to one or to more than one (i.e., to at least one) of the grammatical object of the article. By way of example, “an element” means one element or more than one element. Moreover, usage of articles “a” and “an” in the subject specification and annexed drawings construe to mean “one or more” unless specified otherwise or clear from context to mean a singular form.

As used herein, the terms “example” and/or “exemplary” mean serving as an example, instance, or illustration. For the avoidance of doubt, such examples do not limit the herein described subject matter. In addition, any aspect or design described herein as an “example” and/or “exemplary” is not necessarily preferred or advantageous over other aspects or designs, nor does it preclude equivalent exemplary structures and techniques known to those of ordinary skill in the art.

As used herein, the terms “first,” “second,” “third,” and the like in the description and in the claims, if any, distinguish between similar elements and do not necessarily describe a particular sequence or chronological order. The terms are interchangeable under appropriate circumstances such that the embodiments herein are, for example, capable of operation in sequences other than those illustrated or otherwise described herein. Furthermore, the terms “include,” “have,” and any variations thereof, cover a non-exclusive inclusion such that a process, method, system, article, device, or apparatus that comprises a list of elements is not necessarily limiting to those elements, but may include other elements not expressly listed or inherent to such process, method, system, article, device, or apparatus.

As used herein, the terms “left,” “right,” “front,” “back,” “top,” “bottom,” “over,” “under” and the like in the description and in the claims, if any, are for descriptive purposes and not necessarily for describing permanent relative positions. The terms so used are interchangeable under appropriate circumstances such that the embodiments of the apparatus, methods, and/or articles of manufacture described herein are, for example, capable of operation in other orientations than those illustrated or otherwise described herein.

No element act, or instruction used herein is critical or essential unless explicitly described as such. Furthermore, the term “set” includes items (e.g., related items, unrelated items, a combination of related items and unrelated items, etc.) and may be interchangeable with “one or more.” Where only one item is intended, the term “one” or similar language is used. Also, the terms “has,” “have,” “having,” or the like are open-ended terms. Further, the phrase “based on” means “based, at least in part, on” unless explicitly stated otherwise.

As used herein, the terms “system,” “device,” “unit,” and/or “module” refer to a different component, component portion, or component of the various levels of the order. However, other expressions that achieve the same purpose may replace the terms.

As used herein, the terms “couple,” “coupled,” “couples,” “coupling,” and the like refer to connecting two or more elements mechanically, electrically, and/or otherwise. Two or more electrical elements may be electrically coupled together, but not mechanically or otherwise coupled together. Coupling may be for any length of time, e.g., permanent, or semi-permanent or only for an instant. “Electrical coupling” includes electrical coupling of all types. The absence of the word “removably,” “removable,” and the like, near the word “coupled” and the like does not mean that the coupling, etc. in question is or is not removable.

As used herein, the term “or” means an inclusive “or” rather than an exclusive “or.” That is, unless specified otherwise, or clear from context, “X employs A or B” means any of the natural inclusive permutations. That is, if X employs A; X employs B; or X employs both A and B, then “X employs A or B” is satisfied under any of the foregoing instances.

As used herein, two or more elements or modules are “integral” or “integrated” if they operate functionally together. Two or more elements are “non-integral” if each element can operate functionally independently.

As used herein, the term “real-time” refers to operations conducted as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As used herein, the term “approximately” can mean within a specified or unspecified range of the specified or unspecified stated value. In some embodiments, “approximately” can mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As used herein the term “component” refers to a distinct and identifiable part, element, or unit within a larger system, structure, or entity. It is a building block that serves a specific function or purpose within a more complex whole. Components are often designed to be modular and interchangeable, allowing them to be combined or replaced in various configurations to create or modify systems. Components may be a combination of mechanical, electrical, hardware, firmware, software and/or other engineering elements.

Digital electronic circuitry, or computer software, firmware, or hardware, including the structures disclosed in this specification and their structural equivalents, or in combinations of one or more of them may realize the implementations and all of the functional operations described in this specification. Implementations may be as one or more computer program products i.e., one or more modules of computer program instructions encoded on a computer-readable medium for execution by, or to control the operation of, data processing apparatus. The computer-readable medium may be a machine-readable storage device, a machine-readable storage substrate, a memory device, a composition of matter affecting a machine-readable propagated signal, or a combination of one or more of them. The term “computing system” encompasses all apparatus, devices, and machines for processing data, including by way of example, a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal) that encodes information for transmission to a suitable receiver apparatus.

The actual specialized control hardware or software code used to implement these systems and/or methods is not limiting to the implementations. Thus, any software and any hardware can implement the systems and/or methods based on the description herein without reference to specific software code.

A computer program (also known as a program, software, software application, script, or code) is written in any appropriate form of programming language, including compiled or interpreted languages. Any appropriate form, including a standalone program or a module, component, subroutine, or other unit suitable for use in a computing environment may deploy it. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may execute on one computer or on multiple computers that are located at one site or distributed across multiple sites and interconnected by a communication network.

One or more programmable processors, executing one or more computer programs to perform functions by operating on input data and generating output, perform the processes and logic flows described in this specification. The processes and logic flows may also be performed by, and apparatus may also be implemented as, special purpose logic circuitry, for example, without limitation, a Field Programmable Gate Array (FPGA), an Application Specific Integrated Circuit (ASIC), Application Specific Standard Products (ASSPs), System-On-a-Chip (SOC) systems, Complex Programmable Logic Devices (CPLDs), etc.

Processors suitable for the execution of a computer program include, by way of example, both general and special purpose microprocessors, and any one or more processors of any appropriate kind of digital computer. A processor will receive instructions and data from a read-only memory or a random-access memory or both. Elements of a computer can include a processor for performing instructions and one or more memory devices for storing instructions and data. A computer will also include, or is operatively coupled to receive data, transfer data or both, to/from one or more mass storage devices for storing data e.g., magnetic disks, magneto optical disks, optical disks, or solid-state disks. However, a computer need not have such devices. Moreover, another device, e.g., a mobile telephone, a personal digital assistant (PDA), a mobile audio player, a Global Positioning System (GPS) receiver, etc. may embed a computer. Computer-readable media suitable for storing computer program instructions and data include all forms of non-volatile memory, media and memory devices, including, by way of example, semiconductor memory devices (e.g., Erasable Programmable Read-Only Memory (EPROM), Electronically Erasable Programmable Read-Only Memory (EEPROM), and flash memory devices), magnetic disks (e.g., internal hard disks or removable disks), magneto optical disks (e.g. Compact Disc Read-Only Memory (CD ROM) disks, Digital Versatile Disk-Read-Only Memory (DVD-ROM) disks) and solid-state disks. Special purpose logic circuitry may supplement or incorporate the processor and the memory.

To provide for interaction with a user, a computer may have a display device, e.g., a Cathode Ray Tube (CRT) or Liquid Crystal Display (LCD) monitor, for displaying information to the user, and a keyboard and a pointing device, e.g., a mouse or a trackball, by which the user may provide input to the computer. Other kinds of devices provide for interaction with a user as well. For example, feedback to the user may be any appropriate form of sensory feedback, e.g., visual feedback, auditory feedback, or tactile feedback; and a computer may receive input from the user in any appropriate form, including acoustic, speech, or tactile input.

A computing system that includes a back-end component, e.g., a data server, or that includes a middleware component, e.g., an application server, or that includes a front-end component, e.g., a client computer having a graphical user interface or a Web browser through which a user may interact with an implementation, or any appropriate combination of one or more such back-end, middleware, or front-end components, may realize implementations described herein. Any appropriate form or medium of digital data communication, e.g., a communication network may interconnect the components of the system. Examples of communication networks include a Local Area Network (LAN) and a Wide Area Network (WAN), e.g., Intranet and Internet.

The computing system may include clients and servers. A client and server are remote from each other and typically interact through a communication network. The relationship of the client and server arises by virtue of computer programs running on the respective computers and having a client-server relationship with each other.

Embodiments of the present invention may comprise or utilize a special purpose or general purpose computer including computer hardware. Embodiments within the scope of the present invention may also include physical and other computer-readable media for carrying or storing computer-executable instructions and/or data structures. Such computer-readable media can be any media accessible by a general purpose or special purpose computer system. Computer-readable media that store computer-executable instructions are physical storage media. Computer-readable media that carry computer-executable instructions are transmission media. Thus, by way of example and not limitation, embodiments of the invention can comprise at least two distinct kinds of computer-readable media: physical computer-readable storage media and transmission computer-readable media.

Although the present embodiments described herein are with reference to specific example embodiments it will be evident that various modifications and changes may be made to these embodiments without departing from the broader spirit and scope of the various embodiments. For example, hardware circuitry (e.g., Complementary Metal Oxide Semiconductor (CMOS) based logic circuitry), firmware, software (e.g., embodied in a non-transitory machine-readable medium), or any combination of hardware, firmware, and software may enable and operate the various devices, units, and modules described herein. For example, transistors, logic gates, and electrical circuits (e.g., Application Specific Integrated Circuit (ASIC) and/or Digital Signal Processor (DSP) circuit) may embody the various electrical structures and methods.

In addition, a non-transitory machine-readable medium and/or a system may embody the various operations, processes, and methods disclosed herein. Accordingly, the specification and drawings are illustrative rather than restrictive.

Physical computer-readable storage media includes RAM, ROM, EEPROM, CD-ROM or other optical disk storage (such as CDs, DVDs, etc.), magnetic disk storage or other magnetic storage devices, solid-state disks or any other medium. They store desired program code in the form of computer-executable instructions or data structures which can be accessed by a general purpose or special purpose computer.

As used herein, the term “network” refers to one or more data links that enable the transport of electronic data between computer systems and/or modules and/or other electronic devices. When a network or another communications connection (either hardwired, wireless, or a combination of hardwired or wireless) transfers or provides information to a computer, the computer properly views the connection as a transmission medium. A general purpose or special purpose computer access transmission media that can include a network and/or data links which carry desired program code in the form of computer-executable instructions or data structures. The scope of computer-readable media includes combinations of the above, that enable the transport of electronic data between computer systems and/or modules and/or other electronic devices. The term network may include the Internet, a local area network, a wide area network, or combinations thereof. The network may include one or more networks or communication systems, such as the Internet, the telephone system, satellite networks, cable television networks, and various other private and public networks. In addition, the connections may include wired connections (such as wires, cables, fiber optic lines, etc.), wireless connections, or combinations thereof. Furthermore, although not shown, other computers, systems, devices, and networks may also be connected to the network. Network refers to any set of devices or subsystems connected by links joining (directly or indirectly) a set of terminal nodes sharing resources located on or provided by network nodes. The computers use common communication protocols over digital interconnections to communicate with each other. For example, subsystems may comprise the cloud. Cloud refers to servers that are accessed over the Internet, and the software and databases that run on those servers.

Further, upon reaching various computer system components, program code in the form of computer-executable instructions or data structures can be transferred automatically from transmission computer-readable media to physical computer-readable storage media (or vice versa). For example, computer-executable instructions or data structures received over a network or data link can be buffered in RAM within a Network Interface Module (NIC), and then eventually transferred to computer system RAM and/or to less volatile computer-readable physical storage media at a computer system. Thus, computer system components that also (or even primarily) utilize transmission media may include computer-readable physical storage media.

Computer-executable instructions comprise, for example, instructions and data which cause a general purpose computer, special purpose computer, or special purpose processing device to perform a certain function or group of functions. The computer-executable instructions may be, for example, binary, intermediate format instructions such as assembly language, or even source code. Although the subject matter herein described is in a language specific to structural features and/or methodological acts, the described features or acts described do not limit the subject matter defined in the claims. Rather, the herein described features and acts are example forms of implementing the claims.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

Further, a computer system including one or more processors and computer-readable media such as computer memory may practice the methods. In particular, one or more processors execute computer-executable instructions, stored in the computer memory, to perform various functions such as the acts recited in the embodiments.

Those skilled in the art will appreciate that the invention may be practiced in network computing environments with many types of computer system configurations including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, etc. Distributed system environments where local and remote computer systems, which are linked (either by hardwired data links, wireless data links, or by a combination of hardwired and wireless data links) through a network, both perform tasks may also practice the invention. In a distributed system environment, program modules may be located in both local and remote memory storage devices.

As used herein, the term “Unauthorized access” is when someone gains access to a website, program, server, service, or other system using someone else's account or other methods. For example, if someone kept guessing a password or username for an account that was not theirs until they gained access, it is considered unauthorized access.

As used herein, the term “IoT” stands for Internet of Things which describes the network of physical objects “things” or objects embedded with sensors, software, and other technologies for the purpose of connecting and exchanging data with other devices and systems over the internet.

As used herein “Machine learning” refers to algorithms that give a computer the ability to learn without explicit programming, including algorithms that learn from and make predictions about data. Machine learning techniques include, but are not limited to, support vector machine, artificial neural network (ANN) (also referred to herein as a “neural net”), deep learning neural network, logistic regression, discriminant analysis, random forest, linear regression, rules-based machine learning, Naive Bayes, nearest neighbor, decision tree, decision tree learning, and hidden Markov, etc. For the purposes of clarity, part of a machine learning process can use algorithms such as linear regression or logistic regression. However, using linear regression or another algorithm as part of a machine learning process is distinct from performing a statistical analysis such as regression with a spreadsheet program. The machine learning process can continually learn and adjust the classifier as new data becomes available and does not rely on explicit or rules-based programming. The ANN may be featured with a feedback loop to adjust the system output dynamically as it learns from the new data as it becomes available. In machine learning, backpropagation and feedback loops are used to train the Artificial Intelligence/Machine Learning (AI/ML) model improving the model's accuracy and performance over time. Statistical modeling relies on finding relationships between variables (e.g., mathematical equations) to predict an outcome. ML models are also referred to as Artificial Intelligence (AI) model, Artificial Intelligence/Machine Learning (AI/ML) models, artificial intelligence algorithm, artificial intelligence (AI) engine, and artificial intelligence (AI) agent herein.

As used herein, the term “Data mining” is a process used to turn raw data into useful information. It is the process of analyzing large datasets to uncover hidden patterns, relationships, and insights that can be useful for decision-making and prediction.

As used herein, the term “Data acquisition” is the process of sampling signals that measure real world physical conditions and converting the resulting samples into digital numeric values that a computer manipulates. Data acquisition systems typically convert analog waveforms into digital values for processing. The components of data acquisition systems include sensors to convert physical parameters to electrical signals, signal conditioning circuitry to convert sensor signals into a form that can be converted to digital values, and analog-to-digital converters to convert conditioned sensor signals to digital values. Stand-alone data acquisition systems are often called data loggers.

As used herein, the term “Dashboard” is a type of interface that visualizes particular Key Performance Indicators (KPIs) for a specific goal or process. It is based on data visualization and infographics.

As used herein, a “Database” is a collection of organized information so that it can be easily accessed, managed, and updated. Computer databases typically contain aggregations of data records or files.

As used herein, the term “Data set” (or “Dataset”) is a collection of data. In the case of tabular data, a data set corresponds to one or more database tables, where every column of a table represents a particular variable, and each row corresponds to a given record of the data set in question. The data set lists values for each of the variables, such as height and weight of an object, for each member of the data set. Each value is known as a datum. Data sets can also consist of a collection of documents or files.

As used herein, a “sensor” is a device that detects and measures physical properties from the surrounding environment and converts this information into electrical or digital signals for further processing. Sensors play a crucial role in collecting data for various applications across industries. Sensors may be made of electronic, mechanical, chemical, or other engineering components. Examples include sensors to measure temperature, pressure, humidity, proximity, light, acceleration, orientation etc.

The term “infotainment system” or “in-vehicle infotainment system” (IVI) as used herein refers to a combination of vehicle systems which are used to deliver entertainment and information. In an example, the information may be delivered to the driver and the passengers of a vehicle/occupants through audio/video interfaces, control elements like touch screen displays, button panel, voice commands, and more. Some of the main components of an in-vehicle infotainment systems are integrated head-unit, heads-up display, high-end Digital Signal Processors (DSPs), and Graphics Processing Units (GPUs) to support multiple displays, operating systems, Controller Area Network (CAN), Low-Voltage Differential Signaling (LVDS), and other network protocol support (as per the requirement), connectivity modules, automotive sensors integration, digital instrument cluster, etc.

The term “environment” or “surrounding” as used herein refers to surroundings and the space in which a vehicle is navigating. It refers to dynamic surroundings in which a vehicle is navigating which includes other vehicles, obstacles, pedestrians, lane boundaries, traffic signs and signals, speed limits, potholes, snow, water logging etc.

The term “autonomous mode” as used herein refers to an operating mode which is independent and unsupervised.

The term “vehicle” as used herein refers to a thing used for transporting people or goods. Automobiles, cars, trucks, buses etc. are examples of vehicles.

The term “autonomous vehicle” also referred to as self-driving vehicle, driverless vehicle, robotic vehicle as used herein refers to a vehicle incorporating vehicular automation, that is, a vehicle that can sense its environment and move safely with little or no human input. Self-driving vehicles combine a variety of sensors to perceive their surroundings, such as thermographic cameras, Radio Detection and Ranging (RADAR), Light Detection and Ranging (LIDAR), Sound Navigation and Ranging (SONAR), Global Positioning System (GPS), odometry and inertial measurement unit. Control systems are designed for the purpose of interpreting sensor information to identify appropriate navigation paths, as well as obstacles and relevant signage.

The term “communication module” or “communication system” as used herein refers to a system which enables the information exchange between two points. The process of transmission and reception of information is called communication. The elements of communication include but are not limited to a transmitter of information, channel or medium of communication and a receiver of information.

The term “autonomous communication” as used herein comprises communication over a period with minimal supervision under different scenarios and is not solely or completely based on pre-coded scenarios or pre-coded rules or a predefined protocol. Autonomous communication, in general, happens in an independent and an unsupervised manner. In an embodiment, a communication module is enabled for autonomous communication.

The term “communication connection” as used herein refers to a communication link. It refers to a communication channel that connects two or more devices for the purpose of data transmission. It may refer to a physical transmission medium such as a wire, or to a logical connection over a multiplexed medium such as a radio channel in telecommunications and computer networks. A channel is used for the information transfer of, for example, a digital bit stream, from one or several senders to one or several receivers. A channel has a certain capacity for transmitting information, often measured by its bandwidth in Hertz (Hz) or its data rate in bits per second. For example, a Vehicle-to-Vehicle (V2V) communication may wirelessly exchange information about the speed, location and heading of surrounding vehicles.

The term “communication” as used herein refers to the transmission of information and/or data from one point to another. Communication may be by means of electromagnetic waves. Communication is also a flow of information from one point, known as the source, to another, the receiver. Communication comprises one of the following: transmitting data, instructions, information or a combination of data, instructions, and information. Communication happens between any two communication systems or communicating units. The term communication, herein, includes systems that combine other more specific types of communication, such as: V2I (Vehicle-to-Infrastructure), V2N (Vehicle-to-Network), V2V (Vehicle-to-Vehicle), V2P (Vehicle-to-Pedestrian), V2D (Vehicle-to-Device), V2G (Vehicle-to-Grid), and Vehicle-to-Everything (V2X) communication.

The term “Vehicle-to-Vehicle (V2V) communication” refers to the technology that allows vehicles to broadcast and receive messages. The messages may be omni-directional messages, creating a 360-degree “awareness” of other vehicles in proximity. Vehicles may be equipped with appropriate software (or safety applications) that can use the messages from surrounding vehicles to determine potential crash threats as they develop.

The term “Vehicle-to-Everything (V2X) communication” as used herein refers to transmission of information from a vehicle to any entity that may affect the vehicle, and vice versa. Depending on the underlying technology employed, there are two types of V2X communication technologies: cellular networks and other technologies that support direct device-to-device communication (such as Dedicated Short-Range Communication (DSRC), Port Community System (PCS), Bluetooth®, Wi-Fi®, etc.).

The term “protocol” as used herein refers to a procedure required to initiate and maintain communication; a formal set of conventions governing the format and relative timing of message exchange between two communications terminals; a set of conventions that govern the interactions of processes, devices, and other components within a system; a set of signaling rules used to convey information or commands between boards connected to the bus; a set of signaling rules used to convey information between agents; a set of semantic and syntactic rules that determine the behavior of entities that interact; a set of rules and formats (semantic and syntactic) that determines the communication behavior of simulation applications; a set of conventions or rules that govern the interactions of processes or applications between communications terminals; a formal set of conventions governing the format and relative timing of message exchange between communications terminals; a set of semantic and syntactic rules that determine the behavior of functional units in achieving meaningful communication; a set of semantic and syntactic rules for exchanging information.

The term “communication protocol” as used herein refers to standardized communication between any two systems. An example communication protocol is a DSRC protocol. The DSRC protocol uses a specific frequency band (e.g., 5.9 GHz (Gigahertz)) and specific message formats (such as the Basic Safety Message, Signal Phase and Timing, and Roadside Alert) to enable communications between vehicles and infrastructure components, such as traffic signals and roadside sensors. DSRC is a standardized protocol, and its specifications are maintained by various organizations, including the Institute of Electrical and Electronics Engineers (IEEE) and Society of Automotive Engineers (SAE) International.

The term “bidirectional communication” as used herein refers to an exchange of data between two components. In an example, the first component can be a vehicle and the second component can be an infrastructure that is enabled by a system of hardware, software, and firmware.

The term “alert” or “alert signal” refers to a communication to attract attention. An alert may include visual, tactile, audible alert, and a combination of these alerts to warn drivers or occupants. These alerts allow receivers, such as drivers or occupants, the ability to react and respond quickly.

The term “in communication with” as used herein, refers to any coupling, connection, or interaction using signals to exchange information, message, instruction, command, and/or data, using any system, hardware, software, protocol, or format regardless of whether the exchange occurs wirelessly or over a wired connection.

The term “electronic control unit” (ECU), also known as an “electronic control module” (ECM), is usually a module that controls one or more subsystems. Herein, an ECU may be installed in a vehicle or other motor vehicle. It may refer to many ECUs, and can include but not limited to, Engine Control Module (ECM), Powertrain Control Module (PCM), Transmission Control Module (TCM), Brake Control Module (BCM) or Electronic Brake Control Module (EBCM), Central Control Module (CCM), Central Timing Module (CTM), General Electronic Module (GEM), Body Control Module (BCM), and Suspension Control Module (SCM). ECUs together are sometimes referred to collectively as the vehicles' computer or vehicles' central computer and may include separate computers. In an example, the electronic control unit can be an embedded system in automotive electronics. In another example, the electronic control unit is wirelessly coupled with automotive electronics.

The terms “non-transitory computer-readable medium” and “computer-readable medium” include a single medium or multiple media such as a centralized or distributed database, and/or associated caches and servers that store one or more sets of instructions. Further, the terms “non-transitory computer-readable medium” and “computer-readable medium” include any tangible medium that is capable of storing, encoding, or carrying a set of instructions for execution by a processor that, for example, when executed, cause a system to perform any one or more of the methods or operations disclosed herein. As used herein, the term “computer-readable medium” is expressly defined to include any type of computer-readable storage device and/or storage disk and to exclude propagating signals.

The term “Vehicle Data bus” as used herein represents the interface to the vehicle data bus (e.g., Controller Area Network (CAN), Local Interconnect Network (LIN), Ethernet/IP, FlexRay, and Media Oriented Systems Transport (MOST)) that may enable communication between the Vehicle on-board equipment (OBE) and other vehicle systems to support connected vehicle applications.

The term, “handshaking” refers to an exchange of predetermined signals between agents connected by a communications channel to assure each that it is connected to the other (and not to an imposter). This may also include the use of passwords and codes by an operator. Handshaking signals are transmitted back and forth over a communications network to establish a valid connection between two stations. A hardware handshake uses dedicated wires such as the request-to-send (RTS) and clear-to-send (CTS) lines in a Recommended Standard 232 (RS-232) serial transmission. A software handshake sends codes such as “synchronize” (SYN) and “acknowledge” (ACK) in a Transmission Control Protocol/Internet Protocol (TCP/IP) transmission.

The term “computer vision module” or “computer vision system” allows the vehicle to “see” and interpret the world around it. This system uses a combination of cameras, sensors, and other technologies such as Radio Detection and Ranging (RADAR), Light Detection and Ranging (LIDAR), Sound Navigation and Ranging (SONAR), Global Positioning System (GPS), and Machine learning algorithms, etc. to collect visual data about the vehicle's surroundings and to analyze that data in real-time. The computer vision system is designed to perform a range of tasks, including object detection, lane detection, and pedestrian recognition. It uses deep learning algorithms and other machine learning techniques to analyze visual data and make decisions about how to control the vehicle. For example, the computer vision system may use object detection algorithms to identify other vehicles, pedestrians, and obstacles in the vehicle's path. It can then use this information to calculate the vehicle's speed and direction, adjust its trajectory to avoid collisions, and apply the brakes or accelerate as needed. It allows the vehicle to navigate safely and efficiently in a variety of driving conditions.

As used herein, the term “driver” refers to such an occupant, even when that occupant is not actually driving the vehicle but is situated in the vehicle so as to be able to take over control and function as the driver of the vehicle when the vehicle control system hands over control to the occupant or driver or when the vehicle control system is not operating in an autonomous or semi-autonomous mode. Driver is also referred to as an operator of the vehicle.

The term “application server” refers to a server that hosts applications or software that delivers a business application through a communication protocol. An application server framework is a service layer model. It includes software components available to a software developer through an application programming interface. It is system software that resides between the operating system (OS) on one side, the external resources such as a database management system (DBMS), communications and Internet services on another side, and the users' applications on the third side.

The term “cyber security” as used herein refers to application of technologies, processes, and controls to protect systems, networks, programs, devices, and data from cyber-attacks.

The term “cyber security module” as used herein refers to a module comprising application of technologies, processes, and controls to protect systems, networks, programs, devices and data from cyber-attacks and threats. It aims to reduce the risk of cyber-attacks and protect against the unauthorized exploitation of systems, networks, and technologies. It includes, but is not limited to, critical infrastructure security, application security, network security, cloud security, Internet of Things (IoT) security.

The term “encrypt” used herein refers to securing digital data using one or more mathematical techniques, along with a password or “key” used to decrypt the information. It refers to converting information or data into a code, especially to prevent unauthorized access. It may also refer to concealing information or data by converting it into a code. It may also be referred to as cipher, code, encipher, encode. A simple example is representing alphabets with numbers—say, ‘A’ is ‘01’, ‘B’ is ‘02’, and so on. For example, a message like “HELLO” will be encrypted as “0805121215,” and this value will be transmitted over the network to the recipient(s).

The term “decrypt” used herein refers to the process of converting an encrypted message back to its original format. It is generally a reverse process of encryption. It decodes the encrypted information so that only an authorized user can decrypt the data because decryption requires a secret key or password. This term could be used to describe a method of unencrypting the data manually or unencrypting the data using the proper codes or keys.

The term “cyber security threat” used herein refers to any possible malicious attack that seeks to unlawfully access data, disrupt digital operations, or damage information. A malicious act includes but is not limited to damaging data, stealing data, or disrupting digital life in general. Cyber threats include, but are not limited to, malware, spyware, phishing attacks, ransomware, zero-day exploits, trojans, advanced persistent threats, wiper attacks, data manipulation, data destruction, rogue software, malvertising, unpatched software, computer viruses, man-in-the-middle attacks, data breaches, Denial of Service (DoS) attacks, and other attack vectors.

The term “hash value” used herein can be thought of as fingerprints for files. The contents of a file are processed through a cryptographic algorithm, and a unique numerical value, the hash value, is produced that identifies the contents of the file. If the contents are modified in any way, the value of the hash will also change significantly. Example algorithms used to produce hash values: the Message Digest-5 (MD5) algorithm and Secure Hash Algorithm-1 (SHA1).

The term “integrity check” as used herein refers to the checking for accuracy and consistency of system related files, data, etc. It may be performed using checking tools that can detect whether any critical system files have been changed, thus enabling the system administrator to look for unauthorized alteration of the system. For example, data integrity corresponds to the quality of data in the databases and to the level by which users examine data quality, integrity, and reliability. Data integrity checks verify that the data in the database is accurate, and functions as expected within a given application.

The term “alarm” as used herein refers to a trigger when a component in a system or the system fails or does not perform as expected. The system may enter an alarm state when a certain event occurs. An alarm indication signal is a visual signal to indicate the alarm state. For example, when a cyber security threat is detected, a system administrator may be alerted via sound alarm, a message, a glowing LED, a pop-up window, etc. Alarm indication signal may be reported downstream from a detecting device, to prevent adverse situations or cascading effects.

As used herein, the term “cryptographic protocol” is also known as security protocol or encryption protocol. It is an abstract or concrete protocol that performs a security-related function and applies cryptographic methods often as sequences of cryptographic primitives. A protocol describes how the algorithms should be used. A sufficiently detailed protocol includes details about data structures and representations, at which point it can be used to implement multiple, interoperable versions of a program. Cryptographic protocols are widely used for secure application-level data transport. A cryptographic protocol usually incorporates at least some of these aspects: key agreement or establishment, entity authentication, symmetric encryption, and message authentication material construction, secured application-level data transport, non-repudiation methods, secret sharing methods, and secure multi-party computation. Hashing algorithms may be used to verify the integrity of data. Secure Socket Layer (SSL) and Transport Layer Security (TLS), the successor to SSL, are cryptographic protocols that may be used by networking switches to secure data communications over a network.

The embodiments described herein can be directed to one or more of a system, a method, an apparatus, and/or a computer program product at any possible technical detail level of integration. The computer program product can include a computer-readable storage medium (or media) having computer-readable program instructions thereon for causing a processor to carry out aspects of the one or more embodiments described herein.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer-readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

As used herein the term “driver monitoring system (DMS)” is a technology used in vehicles to track and analyze the behavior of the driver. It involves various sensors and cameras placed inside the vehicle to monitor the driver's actions. These sensors include camera-based systems that capture images, infrared sensors that complement cameras to ensure monitoring in low-light conditions, steering sensors to track the movement of the steering wheel, seat sensors that detect changes in the posture, biometric sensors to measure physiological indicators like heart rate or skin conductivity, etc., gesture recognition technology, etc.

As used herein the term “cabin monitoring system (CMS)” encompasses a suite of technologies installed within a vehicle's interior to oversee users and their activities. Utilizing an array of sensors and strategically placed cameras throughout the cabin, these systems capture and analyze data regarding passengers and their environment. These systems can detect users in various seating positions to ensure appropriate deployment of safety features like airbags. They also monitor passenger movements and actions to identify situations such as unattended children or individuals in distress. Additionally, cabin monitoring systems may include driver monitoring features to detect signs of driver fatigue or distraction. They contribute to vehicle security by detecting unauthorized entry or suspicious activity, triggering alarms or notifications as needed.

As used herein the term “Camera-Based Sensors” refers to sensors that utilize cameras as their primary sensing modality. These sensors incorporate camera technology to capture visual data, which is then processed and analyzed to extract relevant information. Camera-based sensors may further include additional components or functionalities beyond basic image capture, such as depth sensing, infrared imaging, or multispectral imaging. Camera-based sensors may encompass a variety of camera configurations and features tailored to specific monitoring tasks, such as driver monitoring, user detection, object recognition, and/or gesture recognition.

As used herein the term “dynamic tracking” refers to the process of monitoring and updating the position, status, or attributes of objects in real-time as they move or change their position over time due to user-object interaction. Unlike static tracking, which involves monitoring stationary objects or fixed locations, dynamic tracking focuses on tracking objects that can potentially have their location changed. Monitoring may be continuous or may be periodically at regular intervals, where interval may be predefined or adaptive to the current situation of the vehicle and the users. For example, if there is not much activity in the vehicle, as in users and/or the objects are not moving, time gap between two sensors readings may comparatively be higher when compared with a situation where there is high interaction between the users and objects. The system may perform adaptive monitoring based on the current situation in the vehicle.

As used herein the term “monitoring” refers to systematic observation and assessment of a system, process, or environment in real-time or near real-time. It involves the regular collection, analysis, and interpretation of data using various sensors. Monitoring may be continuous or adaptive.

As used herein the term “adaptive monitoring” refers to an approach that dynamically adjusts its parameters, methods, or thresholds based on changing conditions, requirements, or feedback of the system. Unlike static monitoring systems with fixed configurations, adaptive monitoring systems have the ability to modify their behavior in response to evolving circumstances or user-defined criteria. For example, monitoring frequency may be changed based on remaining battery power, detected activity in the vehicle, or required accuracy. Another example includes activating the sensors as needed.

The term “user” as used herein refers to any individual who is inside or on the vehicle. Broadly it may encompass a user inside the vehicle. The terms occupant, passenger, person, may also be used interchangeably to refer to the user of the vehicle.

The term “user profile,” as used herein refers to a set of personalized data associated with an individual. For example, a user profile may include information such as personal details, home address, office address, past trips data, current trip data including start location, exit location, cost of the trip, emergency contact details, alternate contact information of the user, any specific preferences such as instructions for pickup etc. User profile is accessible to the user and the service provider of the registration system. Some of the user profile details may be optional like home address, office address, and some may be mandatory like contact number. User profile is protected using cybersecurity module and encryption.

As used herein, the term “object” refers to a tangible item or thing that can be perceived by the senses. The terms article, entity, thing, are alternate terms and refer to objects.

As used herein, the term “importance of the object” refers to a score which represents how important an object is to the user in a given context. It may or may not be correlated with the value of the object.

As used herein, the term “entry location” refers to a location where passengers board or enter a vehicle at the beginning of their ride.

As used herein, the term “exit location” refers to a location where passengers disembark or exit the vehicle at the end of their ride.

As used herein, the term “reminder” refers to a prompt, notification, or an alert notification designed to help someone remember a task, an event, an items, or a commitment. Reminders can take various forms, including verbal cues, written notes, electronic alerts, or visual signals. They serve as aids to memory, helping individuals stay organized and on track with their responsibilities and obligations. Reminders may be provided via a notification or an alert notification.

The term “vehicle system” or “system of a vehicle” as used herein refers to the vehicle comprising the system described in the current application. The system may be integrated and is a part of the vehicle, for example, a system executing a method on a processor storing instructions in a non-transitory memory of the computer system of the vehicle. The system may be external, but the instructions or method is executed through the vehicle, for example the method being in a cloud but is accessed and executed by the vehicle. The system may be designed for a specific purpose to carry out a certain function or task, for example, transmitting a specific message to a user device. The designed system comprising instructions may also be using existing systems present on the vehicle, for example, a communication system of the vehicle.

The descriptions of the one or more embodiments are for purposes of illustration but are not exhaustive or limiting to the embodiments described herein. Many modifications and variations will be apparent to those of ordinary skill in the art without departing from the scope and spirit of the described embodiments. The terminology used herein best explains the principles of the embodiments, the practical application and/or technical improvement over technologies found in the marketplace, and/or to enable others of ordinary skill in the art to understand the embodiments described herein.

Modern vehicles are equipped with cabin monitoring cameras and radars intended to detect drowsy drivers or unattended children in the vehicle. These interior sensors are largely unused while the vehicle is parked, and usually used for very specific purposes. A privately owned vehicle is parked around 90-96% of its life, meaning that there is great potential to put the sensors to use for other purposes. Personal objects like glasses, clothing, keys, or personal devices are often left behind as a user rushes to exit a vehicle, and the user may not realize that something was left behind until the next time the user needs to use that specific object. The effects of forgetting an object in a vehicle becomes drastically worse if the object was left behind in a vehicle that does not belong to the owner of the vehicle. For the owner of the object, it becomes troublesome to get the object back, and it becomes a nuisance to the owner or main user of the vehicle.

The problem of forgetting objects in the vehicle has probably been around for as long as there have been vehicles. However, there are no known solutions to alerting an individual user about personal objects left behind. Known solutions for detecting objects in the vehicle are limited to detecting humans and animals. This solution is intended for tracking and detecting personal objects that are brought into the vehicle.

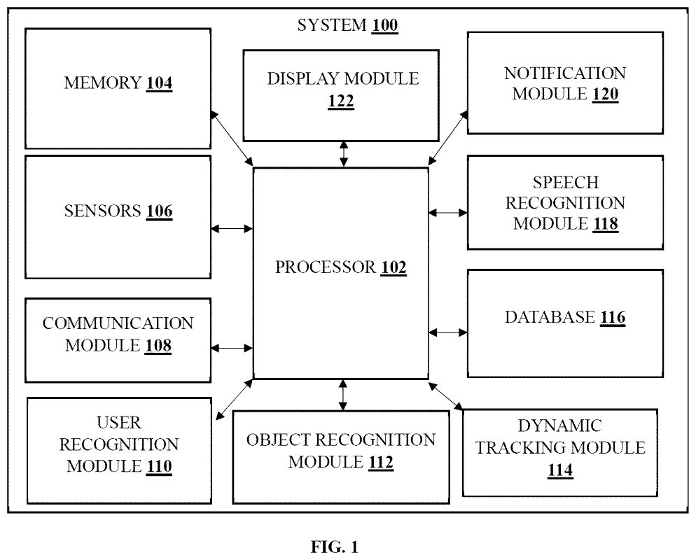

FIG. 1 shows the block diagram of the system for object recognition and reminder system, according to an embodiment. The system 100 comprises a processor 102, memory 104, sensors 106, communication module 108, user recognition module 110, object recognition module 112, dynamic tracking module 114, database 116, speech recognition module 118, notification module 120, and display module 122.

Processor 102: Processor may be a high-performance, multi-core CPU or system-on-chip (SoC) solution to process vast amounts of data from various sensors that may be used. Processor 102 processes data from sensors, such as cameras, LIDAR, radar, and other inputs to make real-time decisions, recommendations, and to execute control actions for the vehicle. Processor 102 may comprise Graphics Processing Units (GPUs). GPUs are utilized for their ability to accelerate tasks like image and sensor data processing. Some vehicles may incorporate Field-Programmable Gate Arrays (FPGAs) to efficiently perform specialized computations, while others might leverage Application-Specific Integrated Circuits (ASICs) for optimized functions. The choice of processor depends on factors such as the vehicle's level of autonomy, processing requirements, power consumption, and thermal considerations. Processors, also known as central processing units (CPUs), are the heart and brain of any computer or electronic device capable of executing instructions. Processor or processors' function is to process data and perform calculations, etc. At the core of their operation lies data processing, where they handle arithmetic and logical operations on data stored in memory. CPUs execute instructions, which are sets of specific operations encoded in machine language, to perform various tasks. The control unit within, or interacting with, the processor manages and coordinates the execution of instructions, fetching them from memory, decoding them, and directing the appropriate components to execute the instruction. To ensure a controlled and orderly flow of tasks, processors use an internal clock that generates regular electrical pulses, synchronizing their operations through clock cycles. Processors support multitasking environments, rapidly switching between executing different tasks for various applications. Additionally, they may work with the operating system to manage virtual memory, allowing programs to access more memory than is physically available, and to efficiently manage memory usage. Processor or processors may be integrated with security features, including hardware-level encryption, memory protection, and support for secure execution environments, enhancing the system's security against potential threats. The processor may run sophisticated algorithms and artificial intelligence (AI) software to analyze sensor data, detect users, interpret the environment, and help in decision making. Its high-performance capabilities and parallel processing help ensure the vehicle can perceive and respond to its surroundings quickly and accurately. In an embodiment, the processor may be a neuromorphic processor, inspired by the human brain, which offers a unique approach to handling AI tasks. The processor interacts and exchanges data with one or more of the other components or modules of the system, for example, memory 104, sensors 106, communication module 108, user recognition module 110, object recognition module 112, dynamic tracking module 114, database 116, speech recognition module 118, notification module 120, and display module 122.

Memory 104: Memory may be a non-volatile memory (NVM) which is utilized in reliable operations of the system, ensuring that data is preserved even during power interruptions or failures. Various NVM technologies are utilized, such as flash memory for storing the operating system and software, EEPROM for retaining configuration data, calibration values, and sensor settings, Ferroelectric RAM (FRAM) for critical real-time information, and emerging technologies like ReRAM for potential performance enhancements due to its high-speed operation and low power consumption. In an embodiment, the memory may be a cloud-based memory. In another embodiment, the memory may be a local memory. In another embodiment, it may be a combination of local and cloud-based memory. Local memory refers to the traditional memory components present in a physical device, such as a computer's RAM, hard disk drives (HDDs), or solid-state drives (SSDs). It provides fast access to data and is directly connected to the device, making it suitable for immediate processing tasks and offline use. On the other hand, cloud-based memory relies on remote servers and services provided by third-party cloud providers to store and manage data over the internet. Systems can access their data from anywhere with an internet connection, allowing for seamless collaboration and scalability. Cloud-based memory is often used for storing large amounts of data, enabling data sharing, and providing backup and disaster recovery solutions. The combination of local memory and cloud-based memory allows for flexible and efficient data management tailored to different needs of the system.

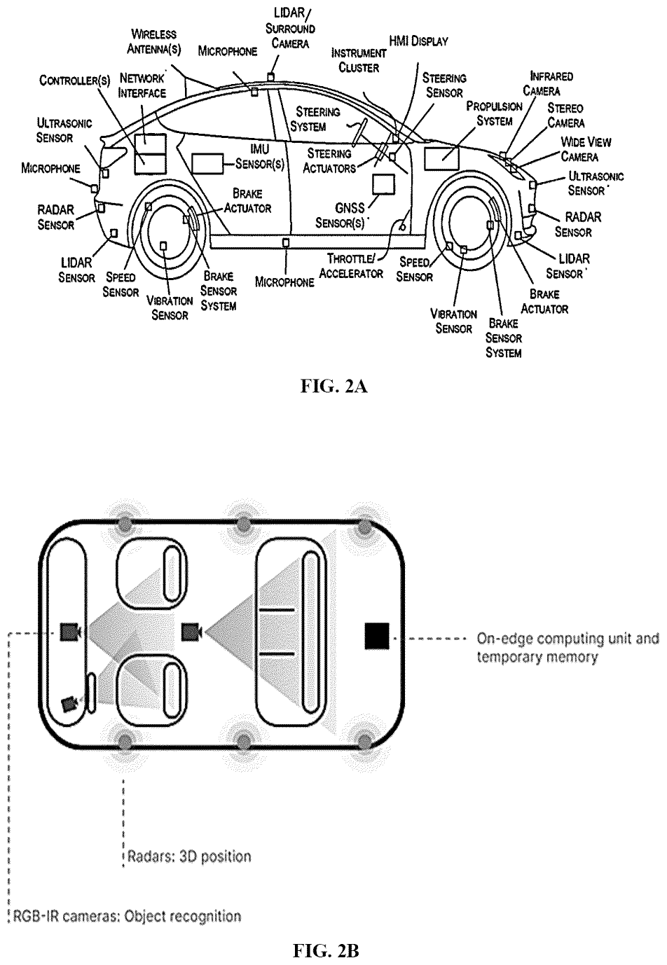

Sensors 106: FIG. 2A is an illustration of a vehicle with various sensors, actuators, and systems according to an embodiment. The system comprises various sensors, such as ultrasonic sensors, LIDAR sensors, radar sensors, camera-based sensors, IR sensors, etc. FIG. 2A is depicted as an example system; neither is it limited by the systems depicted nor is it an exhaustive list of the sensors, actuators, and systems/subsystems, and/or features of the vehicle. Further, the vehicle shown should not be construed as limiting in terms of the arrangement of any of the sensors, actuators, and systems/subsystems depicted. These sensors, actuators, and systems/subsystems can be arranged as suited for a purpose to be performed by the vehicle. In case of autonomous vehicles, also known as self-driving vehicles or driverless vehicles, they can navigate and operate without human intervention. Sensors, for example, including cameras, LIDARs, radars, and ultrasonic sensors enable autonomous vehicles to detect and recognize objects, obstacles, and pedestrians on the road.

FIG. 2B is an illustration of an interior of a vehicle with various sensors arranged strategically according to an embodiment. The vehicle interior may comprise radars and RGB (Red, Green, Blue)-infrared (IR) (RGB-IR) cameras arranged at various positions such that the interior space of the vehicle can be viewed. An RGB-IR camera is a specialized imaging device that captures both visible light (RGB) and infrared (IR) light. By combining color information with data from the infrared spectrum, these cameras offer enhanced capabilities. They typically include separate sensors for RGB and IR light, along with a filter array to separate the incoming light into its components. The captured data can then be fused to create composite images that combine color and infrared information. RGB-IR camera's capability to capture both visible and infrared light provides valuable insights and improved performance in low-light conditions or for specific detection tasks. Cameras comprise at least one of 2D cameras, and 3D cameras. 2D cameras and 3D cameras differ in dimensionality of the visual information they capture. 2D cameras record images in two dimensions, providing flat representations without depth perception, while 3D cameras capture images in three dimensions, including depth information. 2D cameras are commonly used for basic visual tasks like facial recognition; and 3D cameras, since they offer more advanced capabilities such as accurate depth measurement and spatial understanding, may be used for spatial perception of the objects and location of the objects. 2D cameras of cabin monitoring systems are employed to monitor users, detect objects, and identify individuals based on visual features. On the other hand, 3D cameras may be used for precise measurement of distances, gesture recognition, and improved understanding of the spatial layout within the vehicle. 3D cameras are placed strategically within the vehicle, to generate detailed three-dimensional maps of the interior space. These cameras measure distances to objects, allowing for the creation of a spatial model that represents the layout of the vehicle's cabin. By periodically capturing depth information from different vantage points, 3D cameras can construct a comprehensive and dynamic map of the interior environment. This map can comprise details such as the positions of seats, dashboard elements, storage compartments, and objects brought by the users within the vehicle. Additionally, 3D cameras can capture the spatial relationships between these elements, providing valuable insights such as how the objects are moved within the space and whether they are hidden as they are placed inside a seat pocket etc. The mapped interior of the vehicle may enable precise localization of the objects within the vehicle's interior. The system comprises and utilizes the sensors available in the cabin monitoring system and driver monitoring system. Cabin monitoring and driver monitoring systems rely on a variety of sensors to comprehensively monitor the vehicle's interior and the users within. Cameras are used for capturing visual data, enabling facial recognition, user detection, gesture recognition, and object detection within the cabin. Infrared sensors complement by detecting heat signatures and movement, particularly useful in low-light conditions. Depth sensors provide in-depth information for precise 3D mapping of the interior, enhancing spatial understanding and localization of users and objects. Microphones capture audio data for voice recognition, conversation analysis, etc. Pressure sensors detect changes in pressure within seats or floors, indicating the presence and positioning of users and objects. Pressure sensors in the floors may be used for hidden object detection. Biometric sensors measure physiological parameters like heart rate or stress levels, offering insights into users' health. Lidar sensors emit laser pulses to measure distances and create detailed 3D maps of the vehicle's surroundings, contributing to spatial understanding and object detection. Together, these sensors ensure comprehensive monitoring of the vehicle's interior environment, enhancing safety, security, and comfort for users.

In an embodiment, sensors are activated to continuously monitor. In an embodiment, sensors are activated to periodically monitor the cabin. For instance, in electric vehicles, the frequency of monitoring can drain battery power, so in one scenario, monitoring frequency is adjusted based on several factors to optimize battery consumption.

According to an embodiment of the method, the sensors comprise one or more of camera-based sensors, radar, lidar, a microphone, an infrared sensor, a biometric sensor, a gesture recognition sensors, an optical sensor, an ultrasonic sensor, a laser sensor, a weight sensor, a pressure sensor, a motion sensor, a touch sensor, a seat sensor, a door sensor. According to an embodiment of the method, the sensors are located at one or more of the doors of the vehicle and are configured to identify one or more of an entry and an exit of the user into the vehicle. According to an embodiment of the method, the seat sensor is configured to determine the seating position of the user.

According to an embodiment of the system, the sensors comprise one or more of camera-based sensors, radar, lidar, a microphone, an infrared sensor, a biometric sensor, a gesture recognition sensors, an optical sensor, an ultrasonic sensor, a laser sensor, a weight sensor, a pressure sensor, a motion sensor, a touch sensor, a seat sensor, a door sensor. According to an embodiment of the method, the camera-based sensors positioned within the vehicle are configured to capture one or more of images and video footage of the portion of the interior region of the vehicle, wherein the portion is a region of interest and is determined based on the number of the users/passengers and a seating location of each of the users. According to an embodiment of the system, the sensors are located at one or more of the doors of the vehicle and are configured to identify one or more of an entry and an exit of the user. According to an embodiment of the system, the seat sensor is configured to determine the seating position of the user. According to an embodiment of the system, the camera-based sensors positioned within the vehicle are configured to capture one or more of images and video footage of the portion of the interior region of the vehicle, wherein the portion is a region of interest and is determined based on number of the users and a seating location of each of the users. According to an embodiment of the system, the camera-based sensors are configured to rotate automatically for dynamic tracking of the users and the objects. According to an embodiment of the system, the infrared sensor is configured to detect heat signatures to identify a presence of one or more of the users and the objects in low-light conditions. According to an embodiment of the system, the sensors are positioned strategically at one or more locations within the vehicle based on a configuration of the vehicle, for visualization and tracking of movements of the user and the objects. In an embodiment, the cameras do not rotate, but use a standard cabin monitoring system comprising wide-angle cameras.

According to an embodiment of the method, the sensors may further comprise an RGB-IR (Red, Green, and Blue-infrared) camera, a driver monitoring system, a first cabin monitoring method placed in a front region, a second cabin monitoring method placed in a rear region on roof configured for a 2D detection. According to an embodiment of the method, the sensors further comprises one or more radars strategically placed above a side window for 3D detection. According to an embodiment of the method, an input comprising a 3D model and one or more images of the interior region of the vehicle in different light conditions is provided to the first set of artificial intelligence algorithms.

According to an embodiment of the system, the object recognition module comprises the sensors and further comprises an RGB-IR camera, a driver monitoring system, a first cabin monitoring system placed in a front region, a second cabin monitoring system placed in a rear region on roof configured for a 2D detection. According to an embodiment of the system, the object recognition module further comprises one or more radars strategically placed above a side window for 3D detection.

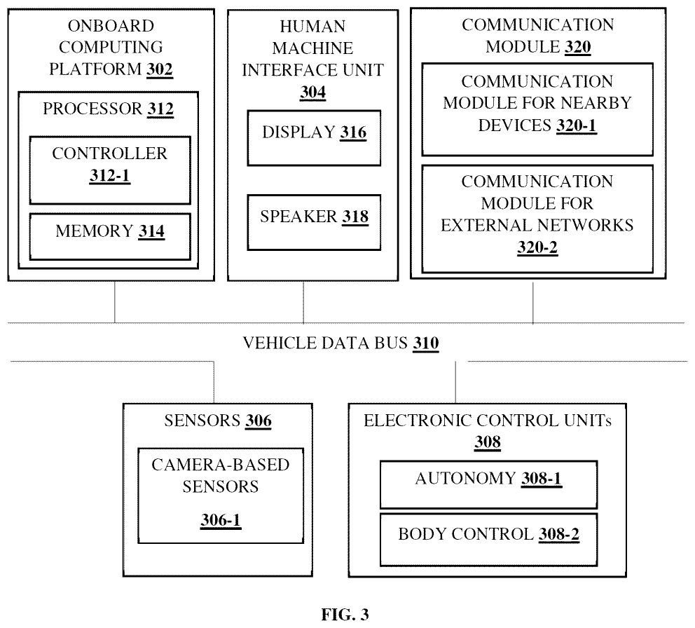

Communication module 108: Communication module facilitates communication between different modules within the system, communication between the vehicle and other devices, vehicle and other vehicles, and other infrastructure components. FIG. 3 shows a block diagram of electronic components of a vehicle according to an embodiment. In the illustrated example, the electronic components comprise an onboard computing platform 302, a human-machine interface (HMI) unit 304, the communication module 320, sensors 306, electronic control units (ECUs) 308, and a vehicle data bus 310. FIG. 3 illustrates an example architecture of some of the electronic components as shown in FIG. 1. The onboard computing platform 302 comprises a processor 312 (also referred to as a microcontroller unit or a controller) and memory 314. In the illustrated example, processor 312 of the onboard computing platform 302 is structured to comprise the controller 312-1. In other examples, the controller 312-1 is incorporated into another ECU with its own processor and memory. The processor 312 may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). The memory 314 may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc.). In some examples, memory 314 comprises multiple kinds of memory, particularly volatile memory, and non-volatile memory. Memory 314 is computer-readable media on which one or more sets of instructions, such as the software for operating the methods of the present disclosure, can be embedded. The instructions may embody one or more of the methods or logic as described herein. For example, the instructions reside completely, or at least partially, within any one or more of the memory 314, the computer-readable medium, and/or within the processor 312 during execution of the instructions.

The HMI unit 304 provides an interface between the vehicle and a user. The HMI unit 304 comprises digital and/or analog interfaces (e.g., input devices and output devices) to receive input from, and display information for, the user(s). The input devices comprise, for example, a control knob, an instrument panel, a digital camera for image capture and/or visual command recognition, a touch screen, an audio input device (e.g., cabin microphone), buttons, or a touchpad. The output devices may comprise instrument cluster outputs (e.g., dials, lighting devices), haptic devices, actuators, a display 316 (e.g., a heads-up display, a center console display such as a liquid crystal display (LCD), an organic light emitting diode (OLED) display, a flat panel display, a solid state display, etc.), and/or a speaker 318. For example, the display 316, the speaker 318, and/or other input and output device(s) of the HMI unit 304 are operable to emit an alert, such as an alert to request manual takeover to an operator (e.g., a driver) of the vehicle. Further, the HMI unit 304 of the illustrated example comprises hardware (e.g., a processor or controller, memory, storage, etc.) and software (e.g., an operating system, etc.) for an infotainment system that is presented via display 316.

Sensors 306 are arranged in and/or around the vehicle to monitor the interior regions of the vehicle and/or an environment in which the vehicle is driving. One or more of the sensors 306 may be mounted to measure various parameters around an exterior of the vehicle. Additionally, or alternatively, one or more of sensors 306 may be mounted inside a cabin of the vehicle or in a body of the vehicle (e.g., an engine compartment, wheel wells, etc.) to measure properties of the vehicle and/or interior sensing of the vehicle. For example, the sensors 306 comprise accelerometers, odometers, tachometers, pitch and yaw sensors, wheel speed sensors, microphones, tire pressure sensors, biometric sensors, ultrasonic sensors, infrared sensors, Light Detection and Ranging (LIDAR/lidar), Radio Detection and Ranging System (radar), Global Positioning System (GPS), millimeter wave (mmWave) sensors, cameras and/or sensors of any other suitable type. Sensors may comprise camera-based sensors 306-1 such as LIDAR, radar, cameras, ultrasonic sensors, GPS sensors, etc., to detect distances between the vehicle and an object or target in its vicinity.

According to an embodiment of the system, the one or more sensors associated with the vehicle comprises one or more of a magnetic sensor, a proximity sensor, a load sensor, an electrical sensor, and a vision sensor, a motion sensor, a temperature sensor, and a GPS sensor. According to an embodiment of the system, the one or more sensors associated with the vehicle comprises camera-based sensors or a camera coupled with a computer vision system.

The ECUs 308 monitor and control the subsystems of the vehicle. For example, the ECUs 308 are discrete sets of electronics that comprise their own circuit(s) (e.g., integrated circuits, microprocessors, memory, storage, etc.) and firmware, sensors, actuators, and/or mounting hardware. The ECUs 308 communicate and exchange information via a vehicle data bus (e.g., the vehicle data bus 310). Additionally, the ECUs 308 may communicate properties (e.g., status of the ECUs, sensor readings, control state, error, and diagnostic codes, etc.) and/or receive requests from each other. For example, the vehicle may have many ECUs that are positioned in various locations around the vehicle and are communicatively coupled by the vehicle data bus 310.

In the illustrated example, the ECUs 308 comprise the autonomy unit 308-1 and a body control module 308-2. For example, the autonomy unit 308-1 is operable to perform autonomous and/or semi-autonomous driving maneuvers (e.g., defensive driving maneuvers) of the vehicle based upon, at least in part, instructions received from the controller 312-1 and/or data collected by the sensors 306 (e.g., object detection sensors). Further, the body control module 308-2 controls one or more subsystems throughout the vehicle, such as power windows, power locks, an immobilizer system, power mirrors, etc. For example, the body control module 308-2 comprises circuits that drive one or more relays (e.g., to control wiper fluid, etc.), brushed direct current (DC) motors (e.g., to control power seats, power locks, power windows, wipers, etc.), stepper motors, LEDs, safety systems (e.g., seatbelt pretensioner, air bags, etc.), etc.

The vehicle data bus 310 communicatively couples the communication module 320, the onboard computing platform 302, the HMI unit 304, the sensors 306, and the ECUs 308. In some examples, the vehicle data bus 310 comprises one or more data buses. The vehicle data bus 310 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc.

The communication module for nearby devices 320-1 is operable to communicate with other nearby communication devices. In an example, communication module 320 comprises a dedicated short-range communication (DSRC) module. A DSRC module comprises antenna(s), radio(s) and software to communicate with nearby vehicle(s) via vehicle-to-vehicle (V2V) communication, infrastructure-based module(s) via vehicle-to-infrastructure (V2I) communication, and/or, more generally, nearby communication device(s) (e.g., a mobile device-based module) via vehicle-to-everything (V2X) communication. V2V communication allows vehicles to share information such as speed, position, direction, and other relevant data, enabling them to cooperate and coordinate their actions to improve safety, efficiency, and mobility on the road. It may rely on dedicated short-range communication (DSRC) and other wireless protocols that enable fast and reliable data transmission between vehicles. V2V communication, which is a form of wireless communication between vehicles, allows vehicles to exchange information and coordinate with other vehicles on the road.

Additionally, or alternatively, the communication module for external networks 320-2 comprises a cellular vehicle-to-everything (C-V2X) module. A C-V2X module comprises hardware and software to communicate with other vehicle(s) via V2V communication, infrastructure-based module(s) via V2I communication, and/or, more generally, nearby communication devices (e.g., mobile device-based modules) via V2X communication. For example, a C-V2X module is operable to communicate with nearby devices (e.g., vehicles, roadside units, mobile devices of users, etc.) directly and/or via cellular networks. Currently, standards related to C-V2X communication are being developed by the 3^{rd} Generation Partnership Project. Further, the communication module 320-2 is operable to communicate with external networks. For example, the communication module 320-2 comprises hardware (e.g., processors, memory, storage, antenna, etc.) and software to control wired or wireless network interfaces. In the illustrated example, the communication module 320-2 comprises one or more communication controllers for cellular networks (e.g., Global System for Mobile Communications (GSM), Universal Mobile Telecommunications System (UMTS), Long Term Evolution (LTE), Code Division Multiple Access (CDMA)), Near Field Communication (NFC) and/or other standards-based networks (e.g., WiMAX (IEEE 802.16m), local area wireless network (including IEEE 802.11 a/b/g/n/ac or others), Wireless Gigabit (IEEE 802.11ad), etc.). In some examples, the communication module for external networks 320-2 comprises a wired or wireless interface (e.g., an auxiliary port, a Universal Serial Bus (USB) port, a Bluetooth® wireless node, etc.) to communicatively couple with a mobile device (e.g., a smart phone, a wearable, a smart watch, a tablet, etc.). In such examples, the vehicle may communicate with the external network via the coupled mobile device. The external network(s) may be a public network, such as the Internet, a private network, such as an intranet, or combinations thereof, and may utilize a variety of networking protocols now available or later developed including, but not limited to, TCP/IP-based networking protocols.

The communication module comprises a hardware component comprising, a vehicle gateway system comprising a microcontroller, a transceiver, a power management integrated circuit, an Internet of Things device capable of transmitting one of an analog and a digital signal over one of a telephone, a communication, either wired or wirelessly.

The autonomy unit 308-1 of the illustrated example is operable to perform autonomous and/or semi-autonomous driving maneuvers, such as defensive driving maneuvers, for the vehicle. For example, the autonomy unit 308-1 performs the autonomous and/or semi-autonomous driving maneuvers based on data collected by the sensors 306. In some examples, the autonomy unit 308-1 is operable to operate a fully autonomous system, a park-assist system, an advanced driver-assistance system (ADAS), and/or other autonomous system(s) for the vehicle.

Further, in the illustrated example, controller (or control module) 312-1 is operable to monitor an ambient environment of the vehicle. For example, to enable the autonomy unit 308-1 to perform autonomous and/or semi-autonomous driving maneuvers, the controller 312-1 collects data that is collected by sensors 306 of the vehicle. In some examples, the controller 312-1 collects location-based data via the communication module 320-1 and/or another module (e.g., a GPS receiver) to facilitate the autonomy unit 308-1 in performing autonomous and/or semi-autonomous driving maneuvers. Additionally, the controller 312-1 collects data from (i) adjacent vehicle(s) via the communication module 320-1 and V2V communication and/or (ii) roadside unit(s) via the communication module 320-1 and V2I communication to further facilitate the autonomy unit 308-1 in performing autonomous and/or semi-autonomous driving maneuvers.

In an embodiment, a connection is established between a vehicle and the user device. The user device is detected by exchanging handshaking signals. Handshaking is the automated process for negotiation of setting up a communication channel between entities. The processor sends a start signal through the communication channel in order to detect a user device. If the user device receives the signal, the processor may receive an acknowledgement signal from the user device. Upon receiving the acknowledgement signal, the processor establishes a secured connection with the user device. The processor may receive a signal at the communication module from the user device. The processor may further automatically determine the origin of the signal. The processor communicatively connects the communication module to the user device. Then the processor is operable to send and/or receive a message to and/or from the user device. The signals received by the communication module may be analyzed to identify the origin of the signal to determine the location of the user device.

In an embodiment, the system is enabled for bidirectional communication. The system or vehicle transmits a signal and then receives a signal/communication from the user device. As a first step, a data link between the vehicle and the external device is set up in order to permit data to be exchanged between the vehicle and the user device in the form of a bidirectional communication. This can take place, for example, via a radio link or a data cable. It is therefore possible for the user device to receive data from the vehicle or for the vehicle to request data from the user device. In an embodiment, bidirectional communication comprises the means for data acquisitions and are designed to exchange data bidirectionally with one another. In addition, at least the vehicle comprises the logical means for gathering the data and arranging it to a certain protocol based on the receiving entity's protocol. Initially, a data link for bidirectional communication is set up. The vehicle and the user device can communicate with one another via this data link and therefore request or exchange data, wherein the data link can be implemented, for example, as a cable link or radio link. Bidirectional communication has various advantages as described herein. In various embodiments, data is communicated and transferred at a suitable time interval, including, for example, 200 millisecond (ms) intervals, 100 ms intervals, 50 ms intervals, 20 ms intervals, 10 ms intervals, or even more frequent and/or in real-time or near real-time, in order to allow a vehicle to respond to, or otherwise react to, data. Bidirectional communication may be used to facilitate data exchange.

According to an embodiment, the communication module supports a communication protocol, wherein the communication protocol comprises at least one of a Advanced Message Queuing Protocol (AMQP), Message Queuing Telemetry Transport (MQTT) protocol, Simple (or Streaming) Text Oriented Message Protocol (STOMP), Zigbee protocol, Unified Diagnostic Services (UDS) protocol, Open Diagnostic eXchange format (ODX) protocol, Diagnostics Over Internet Protocol (DoIP), On-Board Diagnostics (OBD) protocol, and a predefined protocol standard.

In an embodiment, the system may comprise a cyber security module. In one aspect, a secure communication management (SCM) computer device for providing secure data connections is provided. The SCM computer device comprises a processor in communication with memory. The processor is programmed to receive, from a first device, a first data message. The first data message is in a standardized data format. The processor is also programmed to analyze the first data message for potential cyber security threats. If the determination is that the first data message does not contain a cyber security threat, the processor is further programmed to convert the first data message into a first data format associated with the vehicle environment and transmit the converted first data message to the vehicle system using a first communication protocol associated with the vehicle system. According to an embodiment, secure authentication for data transmissions comprises, provisioning a hardware-based security engine (HSE) located in communications system, said HSE having been manufactured in a secure environment and certified in said secure environment as part of an approved network; performing asynchronous authentication, validation and encryption of data using said HSE, storing user permissions data and connection status data in an access control list used to define allowable data communications paths of said approved network, enabling communications of the communications system with other computing system subjects to said access control list, performing asynchronous validation and encryption of data using security engine including identifying a user device (UD) that incorporates credentials embodied in hardware using a hardware-based module provisioned with one or more security aspects for securing the system, wherein security aspects comprising said hardware-based module communicating with a user of said user device and said HSE.

The vehicle system comprises one or more sensors. Sensors may comprise a video camera, microphone, Radio Frequency Identification (RFID) reader, motion sensor, weight sensor, proximity sensor, biometric scanner, Light Detection and Ranging (LiDar) device, Radio Detection and Ranging (Radar) device, beam forming light sensor, audio sensor, and other sensors used to detect a person's identity and/or position within a vehicle. According to an embodiment, the sensor comprises one of a weight sensor, a heat sensor, a motion sensor, a sound sensor, an inertial sensor, a compression sensor, an image sensor, an RFID reader, a smart card reader, and a proximity sensor.

In an embodiment, capacitance-based sensors are used. Capacitance sensors detect changes in capacitance, which can occur when a person occupies a seat. In an embodiment, mmWave radar sensors can be used to detect the users in the vehicle. MmWave radar sensors operate by emitting electromagnetic waves in the millimeter-wave frequency range and then measuring the time it takes for the waves to bounce back after hitting an object. The radar sensor can analyze the reflected signals to detect users. Once the user is detected, user details and profile information can be accessed using various methods.

In an embodiment, the sensors can be placed at strategic locations. In an embodiment, the existing sensors can be used to cover regions of interest in the cabin interior. In an embodiment, the existing sensors can be oriented and used to cover regions of interest in the cabin interior.

In an embodiment, the system may initially use certain sensors and identify more sensors to be activated that might be useful in getting additional details about the object and the user as necessary. In an embodiment, some sensors are active, and some are activated as needed to constantly monitor to reduce the battery power consumption. For example, if there is nobody in the backseat then the sensors that focus on the backseat are inactive. In an embodiment, there may be instances where objects of interest occupy the backseat even if no one is present. The sensors could still be activated regardless of the absence of people. However, if the state remains unchanged for a certain duration, indicating an inactive space, the sensors could then deactivate. In an embodiment, the system is configured for adaptive monitoring, wherein the system uses the sensors adaptively and for continuous monitoring of the interior of the vehicle. The system is configured to determine which sensors are active and which are not, and does not activate the sensors when there are no passengers in the backseat etc.

User recognition module 110: User recognition module of the vehicle system detects a user entering and leaving the vehicle. The users may have to register on a web portal or an application software (App) before using the object recognition and reminder system. If the user is entering the vehicle for the first time, without a prior profile, a new profile can be created, and a unique user identifier will be provided. Sensors such as Lidars radars, cameras, etc., are used to extract the information of the user and will be mapped to the new identifier that the system just detected. Further the system may ask for the inputs from the user or access the information and ask the user to confirm that the accessed information is valid. In an embodiment, the camera may be coupled to a computer vision module.

In an embodiment, for a scenario involving vehicle sharing, a prerequisite for the system is that each user entering the vehicle has an authenticated account either associated with the system or a link with the accounts associated with the sharing service/rental service, allowing the system to link objects to users that the users bring with them. This enables the system to identify which user left the object in the vehicle and notify the right individual. In an embodiment, when more than one user is entering the vehicle, for example, a parent with their kids or a group of friends, the system associates all the users with the user having the account or with the user who did the booking of the vehicle for a ride. In such a scenario, all the kids and their belongings will be associated with the parent account, or all the friends and their belongings will be associated with the user having the account even though the system recognizes them as different individuals. In an embodiment, for a scenario involving vehicle sharing, a prerequisite for the system is that at least one user among group of users entering the vehicle has an authenticated account either associated with the system or a link with the accounts associated with the sharing service/rental service, allowing the system to link objects of the group of users to the account. In an embodiment, the user may have to specify how many individuals will be traveling on their account during booking. In an embodiment, the system may identify the number of individuals traveling along with the user and asks for confirmation if they can be associated with the user account. In an embodiment, the system may collect alternate email addresses and contact numbers and associate the same with each individual in the group either in advance or during the ride.

Vehicle users can be identified by their facial features through the use of facial recognition technology integrated into cabin monitoring systems. This technology relies on cameras positioned strategically within the vehicle to capture images of users' faces. These images are then processed by AI/ML algorithms that analyze facial characteristics such as the size and shape of the eyes, nose, mouth, and other unique features. Through a combination of facial detection algorithms and machine learning, the module distinguishes and recognizes specific facial characteristics, such as the arrangement of eyes, nose, and mouth. The facial recognition module comprises methods that analyze facial landmarks, face geometry, texture, skin color, facial expressions, symmetry, 3D representation, liveness detection, etc. In an embodiment, the module may utilize infrared imaging, and perform age and gender estimation, and contextual information analysis for more information on identification.

By comparing these features against a database of known individuals or stored user profiles, the system can accurately identify users and associate them with specific profiles or accounts. Facial recognition technology is configured such that it can recognize the user in varying lighting conditions and from different angles. In addition to facial recognition, various other methods can be employed to recognize individuals using sensors within a vehicle. Voice recognition technology can be used to analyze speech patterns and vocal characteristics to identify individuals based on their unique voiceprints, commonly employed for hands-free operation, and personalized voice commands. Biometric sensors can be used to measure physiological parameters such as fingerprints, palm prints, iris patterns, or heart rate variability to provide highly accurate and secure identification. Seat occupancy sensors detect individuals based on pressure or weight distribution within the seats, and to know which seat is occupied. This can be used along with other technologies to understand which user is entering, and where he sat based on the changes in seat pressure immediately after entering the vehicle. Wearable devices like smartwatches or RFID tags can serve as identification tokens, communicating with vehicle sensors to provide user identification details. These devices communicate with sensors within the vehicle to authenticate individuals.

Radars, lidars, and Infrared (IR) sensors, though primarily utilized for environmental mapping, collision detection, and object tracking can also contribute to user recognition within vehicles. Radars, by detecting movement patterns or vital signs such as breathing, can discern between different users. Lidar sensors, which create 3D maps of surroundings, can identify individuals based on body shape and motion patterns. Although IR sensors typically monitor temperature and light levels, they indirectly aid user recognition by detecting heat signatures of users, enabling the system to adjust settings based on their presence and position. While these sensors are not conventionally employed for biometric identification, their ability to perceive users' movements and vital signs can be used to know if the identified things are alive or not. When correlated with entry and exit points and the user profiles, these can be adapted to be used for user recognition or help as secondary sensors for user recognition.

In an embodiment, when a person sits in the vehicle, a scanner aided with a microphone may perform facial recognition and/or biometrics to recognize the users. According to an embodiment, the identity of the user is determined using one or more of login credentials, a passcode, a biometric reading, a face recognition, a fingerprint reading, a retina scan, and a voice detection. User details will be stored in the database under the user identifier.

In an embodiment, when the person enters a vehicle, using various technologies, the system will recognize the person. In some of the existing systems, the user, when it is an owner of the vehicle, may be recognized via a key fob.

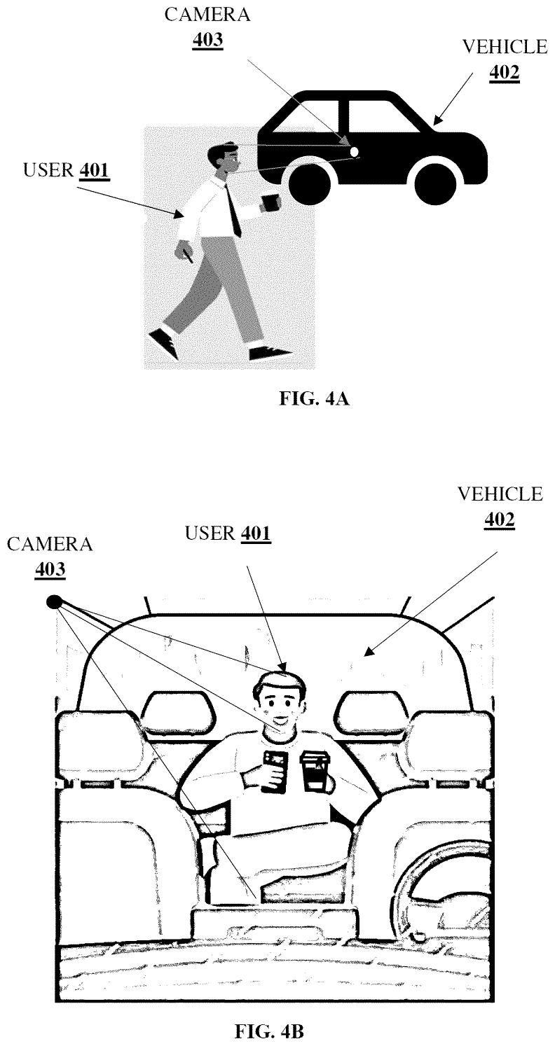

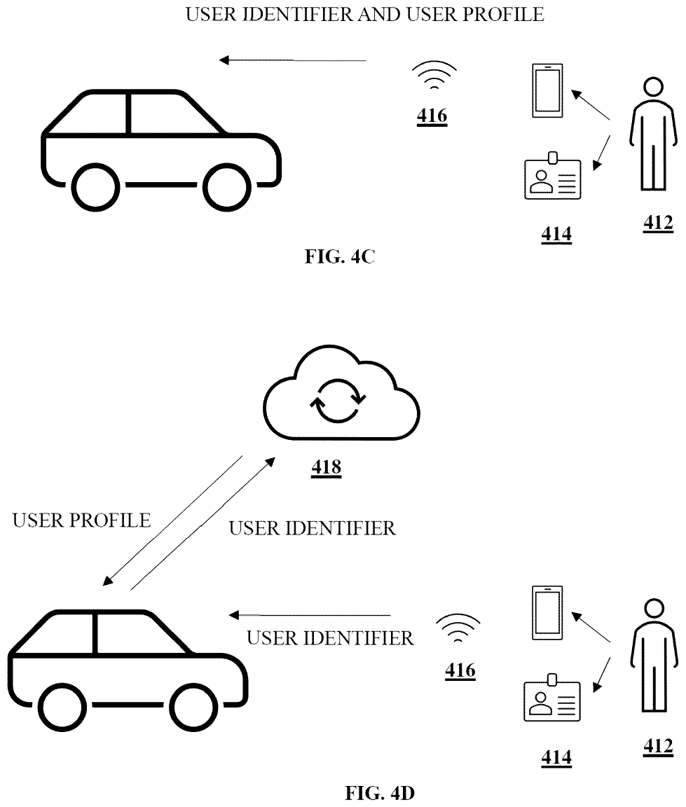

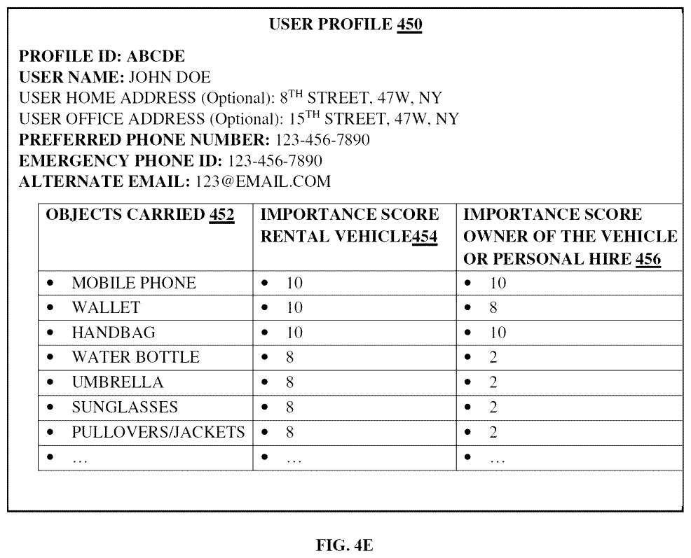

FIG. 4A shows identification of the user when the user is in the proximity to the vehicle according to an embodiment. When the user 401 is in the proximity to the vehicle 402, the vehicle 402 may have camera 403 that can be used for facial recognition of the user. Other sensors, along with cameras, that are present on the vehicle may also be used for other ways of recognizing the user, for example fingerprint scan, iris scan, heat signature, gait analysis etc. Cameras and other sensors such as IR sensors may be, for example, arranged on or near the door of the vehicle, in front of the vehicle, rear to the vehicle, etc. If the system is used on a personal vehicle, then the driver may be recognized based on the key fob. The driver may be the owner, a member of the family, or a friend whose profile could be associated with the key fob. In an embodiment, the door handles may be arranged with sensors for biometric reading of the user, for example iris scan, fingerprint scan etc. In an embodiment, more than one user can be captured via one image when more than one user is entering the vehicle at the same location. In an embodiment, each user may be detected via a separate image corresponding to that user.

FIG. 4B shows identification of the user when the user is in the vehicle according to an embodiment. When the user 401 is in the vehicle 402, the vehicle 402 may have camera 403 interior to the cabin and placed such that it can capture an image of the face of the user wherever he is seated in the vehicle. Such cameras may be used for facial recognition of the user. Other sensors, along with cameras, that are present on the vehicle may also be used for other ways of recognizing the user, for example fingerprint scan, iris scan, heat signature, weight sensors of the seat etc.

The system may behave as if it is the same person. In an embodiment, it is a smart system that determines who the driver is via a key fob, wherein the key fob may comprise a smart tag or an identifier to recognize the driver. In an embodiment, the biometric recognition system may be integrated into the key fob. The key fob may comprise a smart chip which identifies the person via a biometric or a microphone that is integrated into the key fob. The key fob recognizes the person who is operating or handling the key fob and attempting to drive the vehicle. The key fob may pick the correct user profile stored in the key fob. In an embodiment, the key fob may further connect with a cloud system via a network and access the user profile once it recognizes the user. The key fob is no longer just the key but acts as a smart key. In an embodiment, the system of the vehicle may use biometrics of the person to determine the identity via the steering wheel integrated with the biometric system. As soon as the person starts the vehicle and places hands on the steering wheel, the system may determine the identity of the person driving the vehicle.

FIG. 4C shows identification of the user using a personal device or a card according to an embodiment. The user 412 may carry a personal device or an identity tag 414 which can be read by the vehicle readers, scanners, or cameras to identify the user. An identity tag could be an Identity card, an RFID card etc. The user device identification and communication with the user device may be via a communication signal 416 from the communication module. This method of recognition is possible when the user is near to the vehicle or inside the vehicle. The user profile may be accessed directly from the device to access the identification details of the user.

FIG. 4D shows identification of the user using a personal device or a card according to an embodiment. The user 412 may carry a personal device or an identity tag 414 which can be read by the vehicle readers, scanners, or cameras to identify the user. An identity tag could be an identity card, an RFID card etc. The user device identification and communication with the user device may be via a communication signal 416 from the communication module. This method of recognition is possible when the user is near to the vehicle or inside the vehicle. The user profile may be accessed from a cloud 418 using the device identification details. A user identifier could be a mobile phone number, customer identity, service booking identity, biometrics of the user, or any unique code assigned to each user.

FIG. 4E shows a user profile according to an embodiment. User profile 450 comprises user details such as profile identification number which is unique to every user. It could be a registration number, a mobile number, a face identification detail that uniquely describes the user. It further comprises optional details such as name of the user, user home address, office address, and mandatory details such as preferred phone number, emergency contact details, alternate contact details of the user. It may further contain a list of objects with their corresponding importance score where higher scores represent objects being highly important and lower scores represent lower importance. Importance score may be within a predefined range like 1-10 where 10 is most important and 1 is least important. The importance score for each object may be different for rental vehicle, personal vehicle, and/or personal rental vehicle. In an embodiment, the importance scores are generated by the system by default using historical data from many users or a group of users. These scores are editable by the user any number of times. Importance score indicates that the system should notify about the object if left in the vehicle. User profiles are secured by cybersecurity module and are encrypted. Access to user profiles is restricted via authentication requirements.

According to an embodiment of the method, the user profile further comprises one or more of a past trip data, a current trip data comprising entry location, the exit location, and a list of objects with corresponding importance, an emergency contact detail, one or more alternate contact details of the user, a home address of the user, and an office address of the user.

According to an embodiment of the system, the user profile further comprises one or more of a past trip data, a current trip data comprising entry location, the exit location, and a list of objects with corresponding importance. According to an embodiment of the system, the user profile further comprises one or more of an emergency contact detail, one or more alternate contact details of the user, a home address of the user, and an office address of the user.

According to an embodiment, the communication module detects the user device when the user device is in proximity to the vehicle based on a handshake signal. The handshake signal is exchanged via one of a Wi-Fi® signal, a Bluetooth® signal, a near field communication (NFC) signal, a wireless cell signal, and a radio signal.

In an embodiment, the system detects the user or the occupant of the vehicle. Methods that are employed to identify individuals entering could involve technologies such as voice recognition, cameras, direct input from mobile devices such as a pin, biometrics, a fingerprint reader within the key fob, a press to open pad on the vehicle to get fingerprint recognition. The biometrics can comprise face detection; fingerprint identification, eye retina exam, voice fingerprints, a voice command, and combinations thereof.

In an embodiment, the vehicle determines who the user is and accesses his past trips, current trip entry and exit points, vehicle related data on the past trips such as vehicle id, vehicle type, shared ride. etc., and other data in the user profile. The system would take prior permission to access the data from the profile and input the data to the profile. The user profile may be stored locally to the user device, or on a cloud with a cybersecurity interface with encryption and authentication requirements for accessing the data. In case of misidentification or non-identification a temporary profile with the user images and data is stored locally to the vehicle or on a cloud. A further analysis would be done periodically for possible identification.

Object recognition module 112: Object recognition module comprises object recognition models aided by machine learning algorithms to identify various objects based on their visual characteristics. Object recognition models use visual data captured by sensors or cameras to classify and identify specific objects accurately. They can be integrated into systems such as cabin monitoring systems to provide real-time insights and notifications about the presence and location of various objects within a vehicle's cabin. Object recognition models comprise deep learning models, specifically convolutional neural networks (CNNs), which may be used for image classification tasks. These models are trained on large data sets containing images of various objects to learn complex patterns and features to distinguish one object from another.

The object recognition models comprise several steps as described below:

Data Collection and Training: Initially, the object recognition model is trained using a diverse dataset of images representing different objects that may be present in a vehicle's cabin, such as keys, phones, sunglasses, water bottles, briefcase, etc. Training may be provided using various types of sensor data like images, videos, and other sensor data. Videos and images may be from 2D cameras as well as 3D cameras to provide spatial relation and depth information. Images used for training may be as close as possible to the real world situations and could comprise users holding the objects, users leaving the objects, users interacting with the objects etc. Images/videos may be considered for the same object at various locations, various angles, and in various lighting conditions. Each image is labeled with the corresponding object category. For example, objects like keys, purse, phone, sunglasses, water bottle etc., are provided as an example to train the models. A key recognition model is trained to recognize different types of keys, such as house keys, vehicle keys, and locker keys, based on their shape, size, and keychain design. A purse recognition model is designed to identify different styles of purses, including handbags, shoulder bags, clutches, and wallets, based on their overall shape, straps, closures, and decorative elements. A phone recognition model may be trained to recognize different models and brands of smartphones, including iPhone®, android devices, and other mobile phones, based on their screen size, shape, camera placement, and distinctive features. Glasses recognition models may be capable of identifying various styles of sunglasses, such as aviators, wayfarers, cat-eyeglasses, and sport sunglasses, based on their frame design, lens shape, and color. Water bottle recognition model: trained to recognize different types of water bottles, including reusable bottles, sports bottles, and insulated tumblers, based on their size, shape, cap design, and material composition etc. The models are trained to identify the object, its trajectory in case of a video or series of images, object location points, and whether the object is initially hidden and appeared and then hidden or initially present, then hidden, etc., based on the object's location profile.

Model Deployment: Once trained, the object recognition model is deployed within the cabin monitoring system. This may involve running the model on a dedicated computing platform within the vehicle, such as an onboard computer or processor, capable of processing image data/video data captured by sensors or cameras installed in the cabin.

Image Capture and Processing: Sensors or cameras that are strategically placed within the vehicle's cabin capture visual data, including images/videos of objects present in the environment. These images are then processed by the object recognition model, which analyzes them to classify and identify specific objects based on their visual features and provide a label to the object. The model would also provide object location, object trajectory, object location points during the journey, and whether the object is initially hidden and appeared and then hidden or initially present, then hidden, etc., based on the object's location profile.

Real-Time Insights and Notifications: The object recognition model generates real-time insights about the presence and location of various objects within the vehicle's cabin. When an object is detected, the system may be configured to trigger notifications or alerts to inform users or external stakeholders, such as vehicle owners or fleet managers. For example, when an object falls down with or without the notice of the user, the system may provide a beep to alert the user and play a voice message or send a text message of where the object fell in the cabin. These notifications may comprise details about the identified object, its location within the cabin, and any relevant actions to be taken, such as retrieving a forgotten object before exiting the vehicle.

The object recognition models may be integrated into cabin monitoring systems to enhance the system's capabilities to provide accurate and timely information about the objects present in the vehicle's environment for the convenience of the users. In an embodiment, the system would use interior monitoring sensors, a vehicle driver monitoring camera, interior sensors, alarms for detecting if there are unattended children left in the vehicle, and further use these sensors to monitor people that come into a vehicle and bring objects with them, it could be anything like a briefcase, a notebook, a pen, glasses, water bottle, hand bag, purse, clutch, mobile phone, umbrella, a jacket, a scarf, etc. When the person leaves the vehicle, even if there are multiple people inside the vehicle, if one person leaves, the system identifies that the person took, for example, glasses out of their pocket or a bag, and that glasses are left behind in the vehicle. The system would then alert that specific person about what was left in the vehicle.

The system may inform that the person left something in the vehicle and also, using machine learning algorithms, the system could also be more specific about what is the object and where exactly the object was left. For example, the alert could be “You left a pair of glasses in the side door pocket of back seat”, optionally include an image for better depiction of the object and the location.

In an embodiment, the system is configured for a sharing scenario which may have an authenticated account/registration system for the person that comes into the vehicle. The system may use the user registration system for identification of the user and accessing their details from the profile. The system may be further used to associate any type of object that the person brings into the vehicle using the identification details of the person. By doing so, the system can identify who specifically left the object in the vehicle.

In an embodiment, the system identifies or recognizes the object using AI/ML models and provides a label, for example a bag, glasses, keys, laptop, briefcase, mobile etc.

Identifying the objects involves utilizing computer vision techniques to analyze visual data captured by the cameras. The method involves detection and location of the users who are about to board the vehicle within the camera's field of view. User detection can be done using methods like facial recognition or unique identifiers such as RFID tags or mobile phone signals associated with the user. Once the user is identified and authenticated via facial recognition or any other methods, object detection algorithms such as YOLO (You Only Look Once) or Faster R-CNN (Region-based Convolutional Neural Network) may be used to analyze each frame of the camera feed and identify regions containing objects. Once objects are detected, the system classifies them into relevant categories. For identifying objects that the user is carrying, the system may need to recognize common objects such as bags, backpacks, or shopping bags. This classification is usually based on features like shape, color, and texture as described in the object recognition module.

After user identification and object recognition, the system correlates the objects that the user is carrying. The system associates the detected objects with the user. This association can be based on spatial proximity (objects close to the user are likely to be carried by them) or other contextual cues. The system may record the number of objects associated with the user and the location of the object when capturing such association. This may involve techniques to handle occlusion or partial visibility of objects as well. The output of the process is typically a count of the objects that the user is carrying, along with any additional information such as object categories or confidence scores. This information can be used for generating alerts if the user forgets to take important objects when exiting the vehicle.

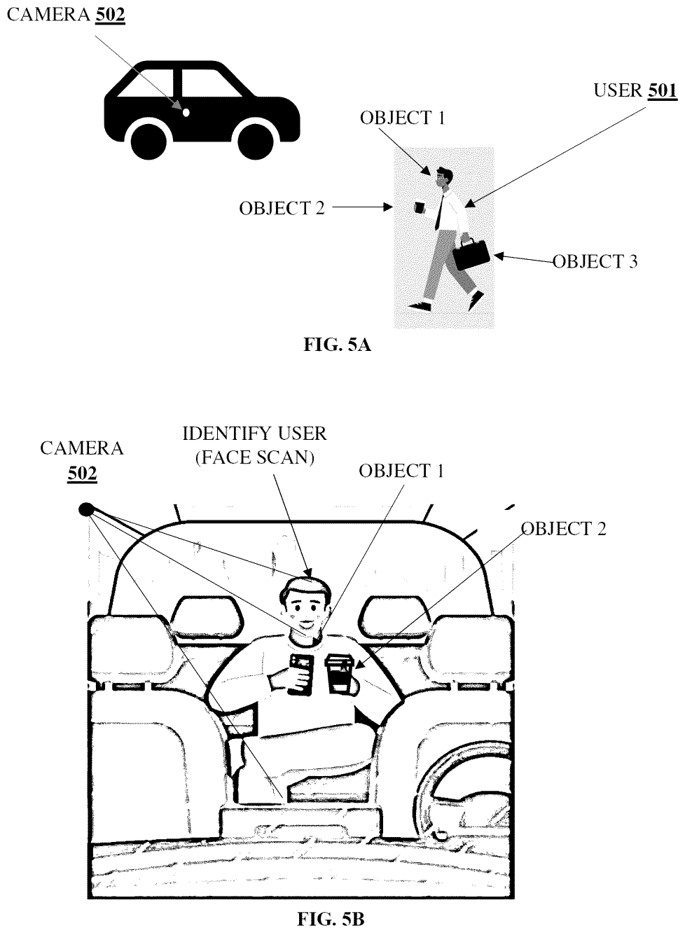

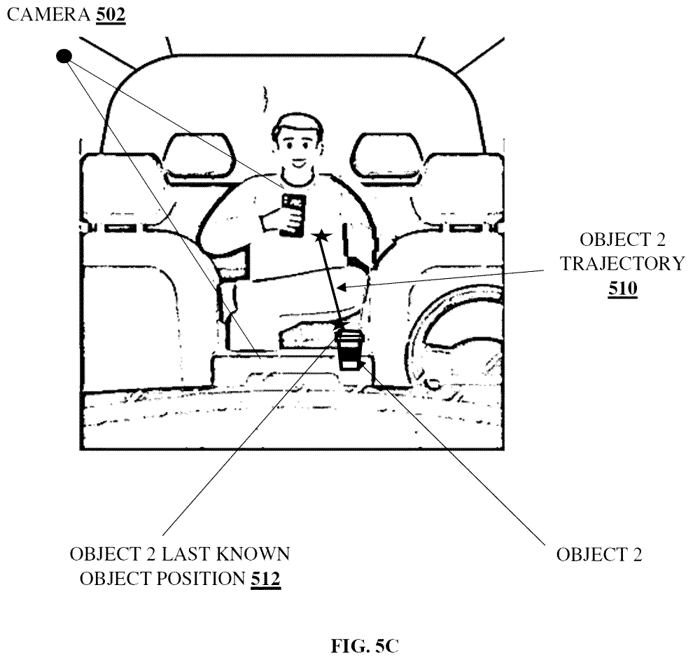

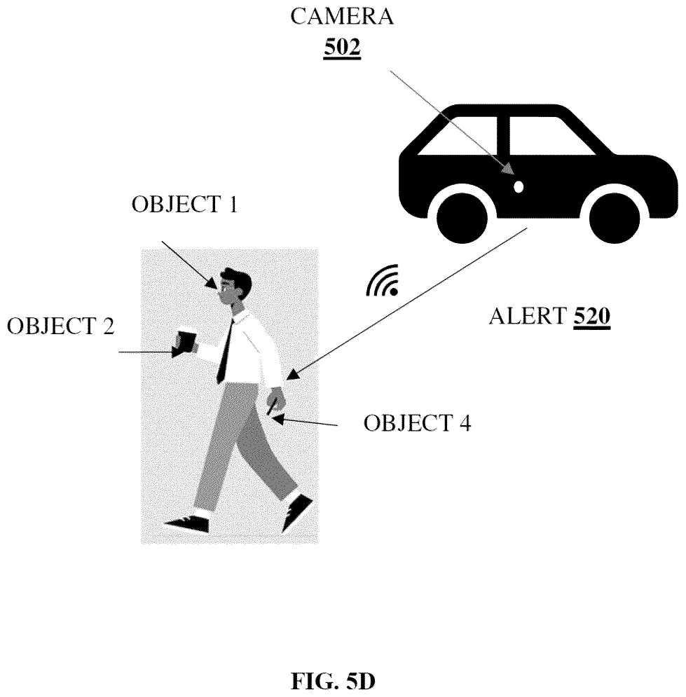

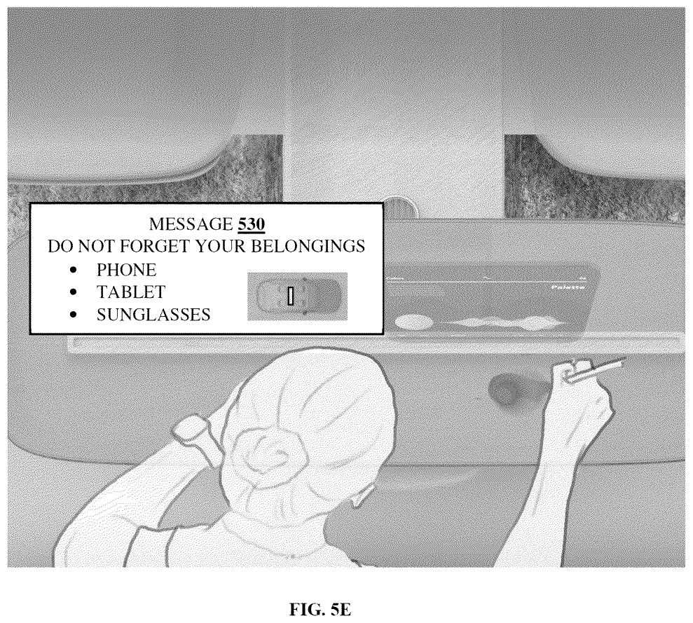

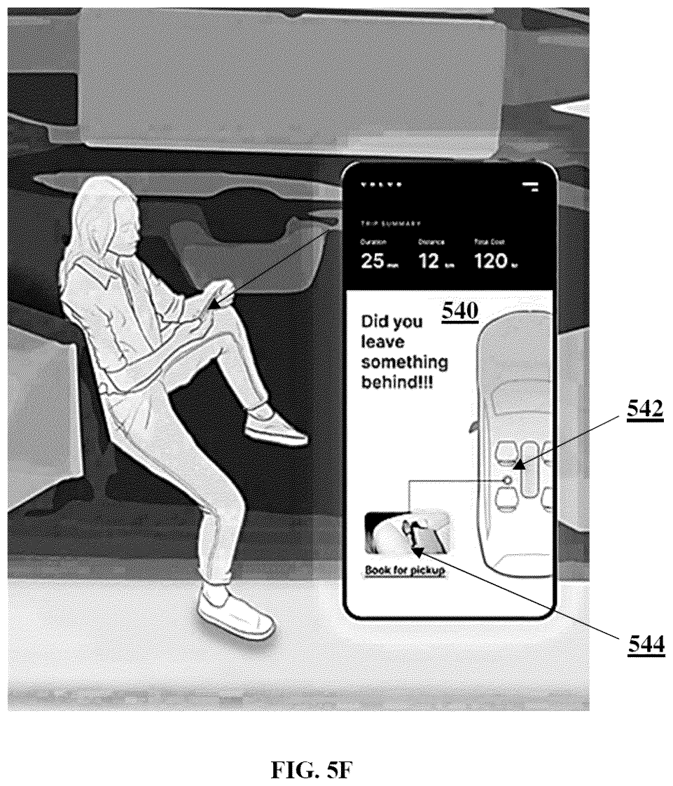

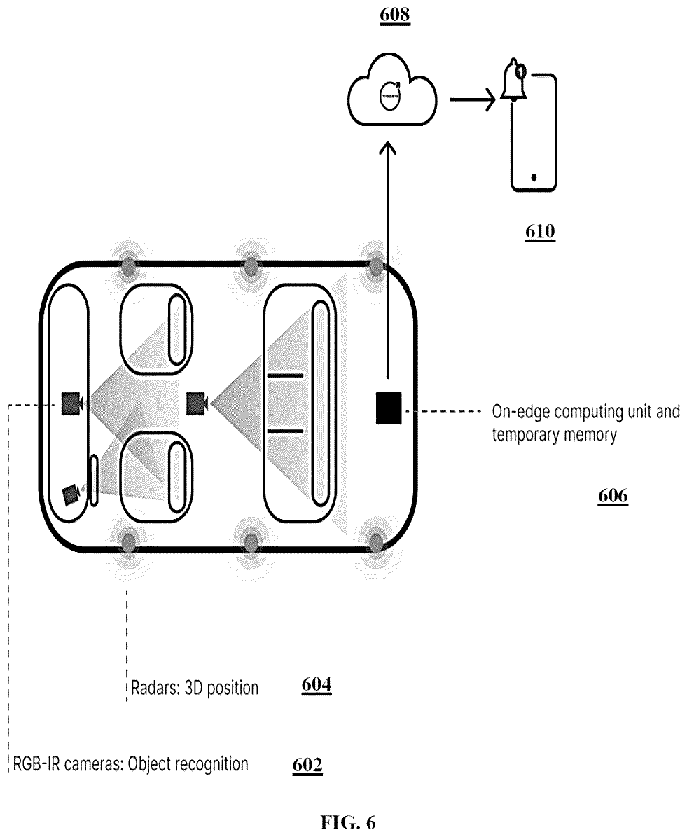

FIG. 5A shows identifying objects that a user is carrying by external cameras on a vehicle according to an embodiment. In this figure the user 501 is identified first and then upon positive identification of the user the objects that the user is carrying are recognized for example Object 1, object 2, and object 3 via a camera 502 of the vehicle. The identified objects may be tagged. FIG. 5B shows identifying objects that a user is carrying by internal cameras of a vehicle according to an embodiment. If the external cameras could not get enough time or appropriate view to capture the user and the objects, or recognize the objects, the internal cameras can be used to identify the user, identify, and tag the objects and associate the objects with the user. In an embodiment, the internal cameras may be used to verify what the external cameras have identified and tagged. In an embodiment, one or more of internal, external, and a combination of internal and external sensors are used for user and object recognition. In an embodiment, more than one user and corresponding objects can be captured via one image when more than one user is entering the vehicle at the same location. In an embodiment, each user and their objects may be detected via a separate image corresponding to that user.

According to an embodiment of the method, the first image of the interior region of the vehicle is taken before the user enters the vehicle and the second image of the interior region of the vehicle is taken after the user exits the vehicle. According to an embodiment of the method, a third image is taken comprising the user at least one of at an entry location and outside the vehicle using external sensors, and immediately after the user enters using the sensors. According to an embodiment of the method, the third image is used to identify the objects that are associated with the user.

According to an embodiment of the system, the first image of the interior region of the vehicle is taken before the user enters the vehicle and the second image of the interior region of the vehicle is taken after the user exits the vehicle. According to an embodiment of the system, a third image is taken comprising the user at an entry location, wherein the third image is taken outside the vehicle using external sensors. According to an embodiment of the system, the third image is taken immediately after the user enters the vehicle using the sensors. According to an embodiment of the system, the third image is used to identify the objects that are associated with the user.

By filtering the data captured from the sensors through image recognition software, the vehicle will be able to compare the end state or exit state of the vehicle to a “zero” state (or start state) of the vehicle, where it is empty from personal belongings, trash, or accessories, to determine if any objects have been left in the vehicle as users are about to exit. The start state and the exit state images are different for each user. The object recognition system utilizes a cabin monitoring system that comprises at least three RGB-IR cameras (DMS, CMS front and CMS rear on roof) for 2D detection and at least 3 to 6 radar, on top of side windows for 3D detection. 2D imaging is used to identify object types and people as shown in FIG. 2B. 3D data defines where and how the objects are moving in space, previous and last position, or if they ended up inside a vehicle compartment.

A basic system may comprise an Artificial Intelligence engine which is fed with a 3D model and pictures of the cabin in different light conditions. The AI engine understands “state 0” or the state before entry of the user, a “start state”. An object identification algorithm is connected to enable the AI engine to identify a wide variety of objects. The AI engine is trained to match object types and space location within the cabin, including if the entity is alive or is an object. The system knows if the vehicle is empty or if there are objects or people and where they are located.

With the basic system it may not be possible to identify if objects are hidden or to whom they belong in case more people are in the vehicle, so adding dynamic tracking could solve those challenges. In addition to the basic features, the system comprises advanced features that identify the number of human passengers and their position by using 2D cameras for biometric identification and 3D sensors for breathing sensing. The AI engine dynamically classifies objects around the passengers (e.g. carried by the passengers or that come from their bodies). Objects can be Active-Objects, meaning the user is interacting with them (connected to human shape), or they can be Inactive-Objects, so discarded or positioned objects (disconnected from human shape, so potentially left behind). The system continuously tracks the identified object's position in space when they leave the human shape. The trajectories will help to identify objects that were positioned in hidden spaces. The data collection frequency could be the same as the CMS (cabin monitoring system) but the data may be processed in a separate unit to save space in CMS for more safety relevant data. The system may have temporary memory storage to save the latest position data. In an embodiment, the camera and sensor system differentiate objects that are native to the interior, for example, attachments like charging cables, phone holders etc., to the ones that are alien to the interior, which people bring in. In an embodiment, the user may add objects/attachments as native to the vehicle by accepting an option on the message which may say add object as native object. In an embodiment, the user may use the vehicle to store an object which may be added as native to the vehicle. The system would then not send a reminder about the object until a specified time interval the user chooses the system to treat the object as native. In an embodiment, the system may also remind the user that the user is accidentally carrying an object which is native to the vehicle, for example the user may by mistake be taking a charging cable which may not belong to the user.

According to an embodiment of the system, the system further comprises an object recognition module comprising object recognition algorithms and a first set of artificial intelligence algorithms configured to analyze data from the sensors and determine one or more of the presence of the objects, recognize the objects; and a location of the objects within the vehicle. According to an embodiment of the system, recognizing the objects comprises classifying the objects and providing a label. According to an embodiment of the system, an input comprising a 3D model and one or more images of the interior region of the vehicle in different light conditions is provided to the first set of artificial intelligence algorithms. According to an embodiment of the system, the first set of artificial intelligence algorithms are trained to match the type of the objects and the location of the object within a space of the interior region of the vehicle. According to an embodiment of the system, the first set of artificial intelligence algorithms are trained to identify the objects as at least one of a living entity and a non-living entity. According to an embodiment of the system, the first set of artificial intelligence algorithms comprise one or more of a convolutional neural network (CNN) architecture, a residual network (ResNet) architecture, an inception network (GoogLeNet) architecture, an efficient network (EfficientNet) architecture. According to an embodiment of the system, the processor is configured to receive one or more images from the sensors, and the objects are recognized based on one or more of object detection parameters comprising one or more attributes of the objects, wherein the attributes comprises a shape, a color, a size, a texture, a trip context, a material, a feature, a pattern, a depth, a unique identification tag, and an RFID tag.

According to an embodiment of the method, the method comprises object recognition algorithms and a first set of artificial intelligence algorithms configured to analyze data from the sensors and determine one or more of the presence of the objects, recognize the objects; and a location of the objects within the vehicle. According to an embodiment of the method, the first set of artificial intelligence algorithms are trained to match the type of the objects and the location of the objects within a space of the interior region of the vehicle. According to an embodiment of the method, the first set of artificial intelligence algorithms are trained to identify the objects as at least one of a living entity and a non-living entity. According to an embodiment of the method, the first set of artificial intelligence algorithms comprise one or more of a convolutional neural network (CNN) architecture, a residual network (ResNet) architecture, an inception network (GoogLeNet) architecture, an efficient network (EfficientNet) architecture. According to an embodiment of the method, the method is configured to receive one or more images from the sensors, and the objects are recognized based on one or more of object detection parameters comprising one or more attributes of the objects, wherein the attributes comprises a shape, a color, a size, a texture, a trip context, a material, a feature, a pattern, a depth, a unique identification tag, and an RFID tag.

According to an embodiment of the method, one or more images are taken by the sensors during a ride and are used for tracking movement patterns of the user and the objects that the user interacted with. According to an embodiment of the method, a video is taken by the sensors during a ride and is used for tracking movement patterns of the user and the objects that the user interacted with. According to an embodiment of the method, the method correlates the objects detected with the user profile based on proximity and a movement pattern, and further maintains an association between the user and the objects using real-time dynamic tracking. According to an embodiment of the method, the method is configured to adaptively refine an association between the user and the objects based on user interaction with other users using real-time dynamic tracking. According to an embodiment of the method, the objects are classified as connected to the user when the user interacts with the objects; and wherein the objects are classified as positioned when the user places the objects with no interaction. According to an embodiment of the method, the objects are tagged as hidden when the objects are out of sight to any of the sensors once the objects are detected.

According to an embodiment of the system, one or more images are taken by the sensors during a ride and are used for tracking movement patterns of the user and the objects that the user interacted with. According to an embodiment of the system, a video is taken by the sensors during a ride and is used for tracking movement patterns of the user and the objects that the user interacted with. According to an embodiment of the system, the system correlates the objects detected with the user profile based on proximity and a movement pattern, and further maintains an association between the user and the objects using dynamic tracking. According to an embodiment of the system, the system is configured to adaptively refine the association between the user and the objects based on user interaction with other users using real-time dynamic tracking. According to an embodiment of the system, the objects are classified as connected to the user when the user interacts with the objects; and wherein the objects are classified as positioned when the user places the object with no interaction. According to an embodiment of the system, the objects are tagged as hidden when the objects are out of sight to any of the sensors once the objects are detected.

Dynamic tracking module 114: In an embodiment, the system uses dynamic tracking, where the system is checking on the belongings or objects of the user, how the user moves them, where they are placed, and whether they are handing it over to the other users. FIG. 5C shows a dynamic tracking of an object according to an embodiment. In FIG. 5B object 2 can be seen initially held by the user after entering the vehicle and in FIG. 5C the same object can be seen placed in front of the user in a cup holder. In FIG. 5C, the location of the object will be the known last recorded location of the object. Dynamic tracking can be periodically done by using a series of images captured after motion detectors detect a motion of the user, or it can also be done by analyzing a video clip. The image processing algorithm considers sensor data and determines the regions of interest based on the objects that the user is interacting with. The region of interest is dynamic and can be changed based on the number of the users, number of objects, interactions of the users, interactions of the users with objects, etc. The sensor determines changes in position of the object from the series of images and with the help of mapped interior space, the objects' location is determined. An object trajectory is formed connecting various known positions for each of the objects as shown in object 2 trajectory 510. Object location in the most recent image is stored as the last known object location 512. This location and image of the object are stored in the database. Similarly, considering object 1, since object 1 is still in the hands of the user and is not placed away from the user, the object 1 trajectory may be given much less priority to follow until object 1 is moved away/kept away by the user. Suppose object 1 is kept away in the user's pocket, the object is not tracked anymore until it is again taken out and used by the user or accidentally falls out. In an embodiment, if there is a hidden object, for example, if the user drops something on the floor, and maybe it rolls under the seat and is not actually visible anymore, and the camera along with the AI algorithms understand that the object cannot be seen anymore, the system assumes the continued existence of the object until the user picks it up or it re-appears. Floor pressure sensors or other sensors, which can aid, will be made active to determine the hidden location. In an embodiment, the hidden objects are determined based on their trajectory during continuous monitoring and sudden disappearance due to obstructing vision and/or sudden disappearance without any user interaction.

In an embodiment, the movement of the users and the movement of the objects is captured via dynamic tracking aided by artificial intelligence algorithms. In an embodiment, tracking with 3d mapping of the interior as well as at least an algorithm to categorize the object through image recognition, and cameras is implemented. In an embodiment, an algorithm detects interior space in the vehicle cabin, through 3D models and radar data, and another AI model can recognize the person and the object and further subcategorize the object as a bag, keys, etc. In an embodiment, the user is recognized via face recognition through the visual camera.

In an embodiment, the person is captured via an image while entering the vehicle with the belongings by using exterior sensors. In an embodiment, the person is captured via an image after entering the vehicle using the interior monitoring sensors. For example, a user is entering with the sunglasses, cameras can recognize that the user entered via door sensors or via camera-based sensors, where the user has sat down, and recognizes the object the user carries or has, and dynamically tracks to know if the user took those off and put them away.

In an embodiment, the system is configured to identify the objects that are forgotten in the vehicle and further determine if the object is alive like a pet or a baby via image processing. In an embodiment, one or more objects that the user carries may have RFID tags which may be used to identify the object and its details. Further, RFID tags may be used to keep a count on the number of objects that were brought into the vehicle and subsequent number of objects that left the vehicle to determine if any object with an RFID tag is left within the vehicle. In an embodiment, the object is identified through RFID tag to know that the object is still inside the vehicle after the user has exited and then the system would try to determine its location within the vehicle based on the RFID tag and notify the user.

Dynamic tracking module comprises cabin monitoring system where live tracking of one or more users and any objects that they bring into the vehicle, thereby creating a relationship between user and object, i.e. who the owner of an object is. The live (continuous) tracking of objects enables the cabin monitoring system to determine the current location of any object. If an object is identified as still in the vehicle as the user is getting ready to exit, the user is notified using displays inside the vehicle or through a notification sent by the vehicle to the user's personal communication device. The notification allows the user to take all objects that they brought into the vehicle before they exit, leaving the vehicle clean and empty of “non-native” objects. Artificial Intelligence and Machine Learning Models may be trained using machine learning to identify the type of object and the name, its location, allowing notifications to be more precise about what is left behind and where it is located, for example, the notification could be “a pair of glasses in the door pocket”.

According to an embodiment of the system, the dynamic tracking generates a trajectory and a location of the objects, wherein the location is tagged with the objects. According to an embodiment of the system, the sensors are in communication with a control unit of the vehicle.

According to an embodiment of the method, the dynamic tracking generates a trajectory and a location of the objects, wherein the location is tagged with the objects. According to an embodiment of the method, the sensors are in communication with a control unit of the vehicle.

Database 116: The system stores various types of data that can be stored in a database for processing, analysis, and future reference. This comprises storing raw image data captured by the sensors. Additionally, metadata about detected objects such as type, location within the image frame, size, and confidence scores from object detection algorithms can be recorded. User data, comprising unique identifiers like RFID tags or user IDs, as well as facial recognition data, alongside any associated metadata, is also stored. Furthermore, the system logs important events such as object detections, user identifications, for performance monitoring and issue resolution. Configuration settings, like camera calibration parameters are stored to ensure consistent system behavior. The database's role extends to efficient data retrieval, analysis for insights such as user behavior trends, and facilitating data management tasks like cleaning and security measures such as access control and encryption. In an embodiment, the database may serve as a repository. Portions of data may be stored temporarily, and portions of data may be stored for long term.

According to an embodiment of the system, data of a trip comprising entry location, the exit location, list of objects carried, tracking data of the user and the objects, forgotten objects, the first message is saved to a database, wherein the database is located locally or in a cloud.

When the user forgets phone or mobile phone through which he receives alerts primarily, then the system may try to connect to any other wearable devices that may be with the user and alert. It could be via handshake connection or via a short range signal such as Bluetooth® to the nearby device that the person owns that may be connected via the mobile phone. In another embodiment, the system provides a message outside of the vehicle within a predefined proximity either to the user's primary device (such as mobile phone), a secondary device (connected to a mobile phone), or an independent device which can be connected and authenticated by the user. In an embodiment, the communication may be through auditory means. For example, when the user tries to exit with a forgotten thing inside, could the vehicle invite attention through a directional sound.

Speech recognition module 118: The system may integrate natural language processing (NLP) capabilities using a speech recognition module to further enhance its functionality. By incorporating NLP, the system can interpret spoken commands or inquiries from the user regarding forgotten objects. The speech recognition module enables the system to accurately transcribe spoken words into text, allowing users to communicate with the system using natural language. For instance, if a user transmits a verbally expressed concern about a lost object to the vehicle, such as “Did I leave my laptop in the vehicle?”, the speech recognition module of the system in the vehicle would capture this voice message and convert it into a textual representation. Once the spoken input is transcribed, the NLP component of the system analyzes the text to determine the user's intent and extract relevant information. In this example, the intent may be to inquire about the presence of a specific object (laptop) in the vehicle he used previously. The NLP model parses the text to identify keywords and contextually understands the user's request.

Upon recognizing the user's intent and extracting the relevant message, the system can respond accordingly. For instance, if the system detects that the user is concerned about their laptop, it can access the database to determine if the laptop was detected in the vehicle during the monitoring session when the user took the ride. Based on this information, the system can provide a response to the user, such as “Yes, a laptop was detected in the vehicle. Please describe more details about the laptop to claim it as yours.” The system then sends the message to the user and upon receiving additional description it may send corresponding pictures confirming that the laptop was forgotten in the vehicle during the ride. Further the user can schedule a ride to collect the laptop, or the system can schedule a ride to drop off the laptop at a specified location as chosen by the user. For Natural Language Processing (NLP), models that may be used for understanding and processing human language are BERT (Bidirectional Encoder Representations from Transformers), a pre-trained model developed by Google®. Unlike traditional models, BERT is bidirectional, allowing it to consider both left and right contexts of words in a sentence, thus understanding their meaning within the larger context. Additionally, specialized variants of BERT, such as BERT-QA for question answering, and models like Word2Vec for word embedding, Long Short-Term Memory (LSTM) for sequential data processing, and Transformer-XL for handling longer sequences may also be used. These models leverage deep learning techniques to extract meaningful representations from text data, enabling text classification, sentiment analysis, language translation, and more.

In an embodiment, the system communicates about the objects left in the vehicle from the vehicle to the user. In another embodiment, the vehicle receives communication from the user. For instance, a user could notify the vehicle that an object is lost and may specify additional details of the object. Utilizing a basic language model, the vehicle could comprehend this information and acknowledge it accordingly. Therefore, a two-way communication system is integrated with the monitoring capabilities.

In an embodiment, the users can initiate communication with the vehicle. For instance, one could verbally inquire if a specific object has been found and leave contact information. If detailed descriptions are provided, such as specifying a color of the object, object type etc. then the system in the vehicle would process the data with natural language processing, understand the features of the object lost, analyze collected data, including image and object recognition and determine if the object is present and matches with the user's object description.

According to an embodiment, the system is capable of receiving a message that describes an object, and then it has to process and see whether that object is in there. If it is then it has to communicate and possibly locate and provide a location of it. According to an embodiment, it is a system for object identification and location, comprising a message reception module configured to receive a message describing an object; a processing module configured to analyze the received message and determine if the described object is present within the vehicle; a communication module configured to initiate communication upon confirming the presence of the described object; and a location module configured to provide the location of the identified object within the vehicle interior. A message could be received as a voice message, an image, a text message, or a combination of any.

Notification module 120: At the end of the journey or trip, for which the triggers could be one or more of parked vehicles, locked vehicles, and end of rideshare journey via a service API, the AI engine retrieves the latest positions and determines if some object was left behind. The “left behind” process activates only if objects were left by the user and are visually identified inside the cabin or, as their last trajectory defines, they are hidden somewhere in the cabin. Nothing happens if the object was handed over to another user or placed into another bag. The relevant data are compressed and sent to a cloud and associated to a user account, by using face identification technique connected to the account. A notification is generated and sent to the preferred device. The text will comprise object type, location in the cabin and vehicle ID. The notifications could be multiple (for each object) or single (all objects in one vehicle).

The system is configured to have different levels of alerts, depending on the type of objects. For example, for a wallet or phone, the system may choose a high alert. If it is an object such as a water bottle, then a low alert may be produced. In a shared scenario, to avoid people littering the vehicle, the alerts may be of equal importance.

FIG. 5D shows a user exiting the system alert system for user near to the vehicle versus far away from the vehicle. In FIG. 5D the system recognizes that the user is exiting from the vehicle. FIG. 5A shows the user when entering the vehicle. The system would compare the objects that are recognized with the user while entering to the objects that the user is leaving with using image processing methods by capturing images using a camera 502. If there is a mismatch found the system would immediately send an alert signal 520. The same conclusion can also be achieved by filtering the data captured from the sensors in and around the vehicle through image recognition software, the vehicle will be able to compare a “zero” state or start state of the vehicle, where it is empty from personal belongings, trash, or accessories, to determine if any objects have been left in the vehicle as users are about to exit or immediately after the exit which is an exit state of the vehicle.

The system is configured to identify the object that is left behind and provide an alert, but the alert provided may have two or more levels. First one, is when the user is inside the vehicle and before the user leaves, identifying certain objects that may be forgotten; and second, when the user is in the proximity of the vehicle, for example, just got down and about say a few feet (may be 10-20 feet) away with a potential to get back to the vehicle immediately and collect; and a third when the user is away from the vehicle and has to schedule for a collection of the forgotten object.

In an embodiment, the system would be configured such that a friend of the user may be allowed to collect the phone. The camera-based sensors can be used to recognize the friend and leave the object with the friend. Details of the friend may be obtained from the owner of the object and after the collection of the object, the user may get the confirmation with a message from the person who collected the object, the place where the object is collected. The message may comprise one or more pictures taken by the camera. The authentication of the friend may be via a biometric, face recognition, a pin, or via a shared pin between the user and the friend which needs to be entered in real-time in the system for authentication, a kind of layered authentication, double authentication, or multiple user authentication. In another embodiment, the notification can be received on different devices which may be connected to Google®, Samsung®, Apple® accounts. In an embodiment, the notification system is via a cloud and not related to direct messaging to one particular device.

In an embodiment, various methods are used to notify users when they misplace their object or any primary device. In an embodiment, an urgency of the situation, for instance, in a shared vehicle scenario, the alert level differs from that of a personal vehicle. In an embodiment, the alert is customized based on the type of object lost, starting with less intrusive alerts, and escalating if there is no response. For example, if someone forgets their phone, they might receive notifications on other devices or via email until they acknowledge the alert. In an embodiment, it is a smart system that adapts to different situations and notifies users effectively.

According to an embodiment of the system, the system further comprises an alert generation module, configured to notify the user about the objects. According to an embodiment of the system, the alert generation module is configured to provide the alert via one or more of a visual, an auditory, and a haptic feedback. According to an embodiment of the system, the first message notifies the user using one or more of a display inside the vehicle, via a loudspeaker, and the user device. According to an embodiment of the system, the first message is customized based on a type of the vehicle, wherein the type of the vehicle is one of a rental, a personal hire, and an owned vehicle. According to an embodiment of the system, the first message is communicated to an alternate contact information provided in the user profile. According to an embodiment of the system, the system updates the user profile with information about the objects, wherein the information comprises object recognition data, location of the objects, and an importance score of the objects. According to an embodiment of the system, the information about the objects is changeable by the user. According to an embodiment of the system, the first message is further customized based on the type of the objects and the importance score of the objects in the user profile. According to an embodiment of the system, the first message comprises identity of the one or more of the objects and the location of the objects. According to an embodiment of the system, the first further comprises image of the objects. According to an embodiment of the system, the system is configured to interact with an application software on a mobile device.

Display module 122: The system would share information about an object that seems like it will be left behind in the vehicle, on a screen inside the vehicle and located before the person who is getting out of the vehicle. FIG. 5E shows a message on an in-vehicle display to alert users to not forget personal objects that have been identified by the vehicle according to an embodiment. A message 530 is displayed on the infotainment system or a display in front of the user who is about to exit.

FIG. 5F shows a message about objects left behind in the vehicle sent to the user's personal device according to an embodiment. In an embodiment, a digital account of the user is used to share information over a cloud to their personal device, like a phone, if the user has left the vehicle. The user may be alerted through a message indicating that they have left an object in the vehicle as soon as possible. If it is a shared vehicle, and the user walks away from the vehicle, and no longer has access to that vehicle, then the message is shared on a personal device 540. The message may comprise one or more of a location of the object 542, and a picture of the object 544.

Display module 122, in the vehicles may be connected to the notification module 120 through the vehicle's onboard computer or electronic control unit (ECU) according to an embodiment. Any message sent to the display module by the notification module is presented to the user on the vehicle's infotainment system, played via a speaker, or sent to a user's personal device. The connection between notification module 120 and the display module 122 is established through a communication network within the vehicle. Modern vehicles use Controller Area Network (CAN) or other communication protocols to transmit data between different electronic components, including the alert system and the display module.

Once the signal reaches the display module, it activates the appropriate visual and audible alerts to inform the users. In another embodiment, the display module may also generate pop-up alerts on the infotainment or navigation screen. Furthermore, the vehicle may be equipped with haptic feedback capabilities, the display module 122 can trigger haptic alerts, such as gentle vibrations in the seat, to provide an additional tactile cue to the user.

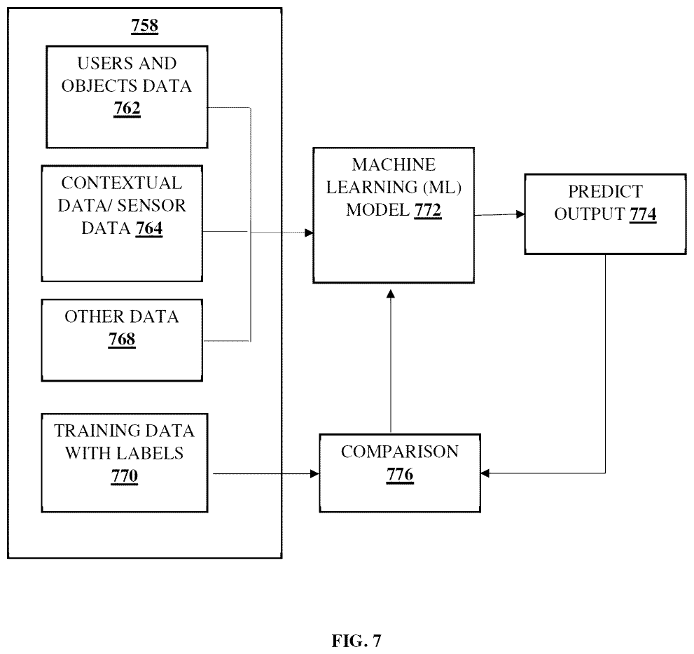

FIG. 6 shows hardware of the system for object recognition reminder system according to an embodiment. The object recognition system utilizes a cabin monitoring system that comprises at least three RGB-IR cameras shown as 602, a DMS, a CMS front and a CMS rear on roof for 2D detection and at least 3 to 6 radars on top of side windows for 3D detection shown as 604. 2D imaging is used to identify object types and people. 3D data defines where the objects are moving in space (previous and last position) or if they ended up inside a vehicle compartment. The system comprises an AI engine trained with 3D models and images of an empty cabin under various lighting conditions, to determine “state 0” or “start state” of the vehicle cabin. Integrated with an object identification algorithm, the AI engine can recognize diverse objects. Through training, the AI engine learns to associate object types with their spatial locations within the cabin, discerning between living entities and objects. Consequently, the system can determine whether the vehicle is unoccupied or occupied by objects or people, along with their respective locations. While the basic system lacks the capability to detect hidden objects or determine ownership when multiple users are present in the vehicle, integrating dynamic tracking can be used to address these limitations. The system discerns the number and positions of human passengers through 2D cameras for biometric identification and 3D sensors for detecting breathing patterns. An AI engine dynamically categorizes objects surrounding the passengers, distinguishing between objects carried by them or originating from their vicinity. Objects are classified as either Action-Objects, indicating interaction with the user and connected to the human shape, or Inactive-Objects, representing discarded or stationary objects disconnected from human form and potentially left behind. Continuous tracking of identified objects' spatial positions occurs, particularly after they depart from the human shape, enabling the system to track objects located in concealed areas. Data collection frequency may align with the Cabin Monitoring System (CMS), although processing may occur in a separate unit to conserve space in the CMS. Temporary memory storage is maintained for retaining the latest position data. In an embodiment, the system comprises on-edge computing units and temporary memory 606. On-edge computing units refers to hardware components installed within the vehicle that are responsible for processing data locally, without relying on external servers or cloud services. This unit typically comprises a specialized computer or microcontroller with sufficient processing power and memory to perform computations in real-time. Its function is to execute algorithms and analyze data collected by the system's sensors, cameras, and other input devices. Temporary memory, also known as volatile memory or RAM (Random Access Memory), is a type of computer memory that temporarily stores data and instructions that the CPU (Central Processing Unit) needs to access quickly. In the context of the system described, temporary memory is utilized to store the latest position data of identified objects within the vehicle. This allows the system to keep track of objects in real-time during the journey, facilitating easy and efficient processing and analysis. On-edge computing unit and temporary memory enable the system to perform dynamic tracking, object recognition, and notification generation tasks locally within the vehicle, without relying on continuous communication with external servers. This localized processing enhances the system's responsiveness, reduces latency, and ensures reliable operation even in environments with limited or intermittent network connectivity.

At the end of the journey, which may be found by triggers such as parked vehicle, locked vehicle, end of rideshare journey via service API, or a user exit event, the AI engine retrieves the latest positions and determines if something was left behind. The “left behind” process activates only if objects left the user and are visually identified inside the cabin or their last trajectory defines, they are hidden somewhere in the cabin. The “left behind” process does not activate if the object was handed over to another user or placed into another bag. The relevant data are compressed and sent to a cloud 608 and associated to the correct account using face ID connected to the account. A notification is generated and sent to the user preferred device 610. The text comprises object type, location in the cabin and vehicle ID. The notifications could be multiple, i.e., one notification for each object or a single notification when all objects belong to one user.

The one or more sensors may comprise a piezoelectric weight sensor, a Hall effect weight sensor, a strain gauge weight sensor, and/or the like located under a trunk plate of the vehicle, under one or more seats of the vehicle, under one or more floor panels of the vehicle, and/or the like; a camera located within the vehicle; a radar sensor located within the vehicle; a sound sensor located within the vehicle; a motion sensor located within the vehicle; and/or the like. In some implementations, the user devices and the vehicle may be associated with a notification platform. In some implementations, the one or more sensors may communicate with the user device of the driver, a vehicle control system of the vehicle, the user device of the passenger, the notification platform, and/or the like.

User device comprises one or more devices capable of receiving, generating, storing, processing, and/or providing information, such as information described herein. For example, user device may comprise a mobile phone (e.g., a smart phone, a radiotelephone, etc.), a laptop computer, a tablet computer, a desktop computer, a handheld computer, a gaming device, a wearable communication device (e.g., a smart wristwatch, a pair of smart eyeglasses, etc.), or a similar type of device. In some implementations, user devices may receive information from and/or transmit information to notification platforms and/or server devices. User device may comprise an Application Software (API) that integrates with the object recognition and reminder system.

Notification platform comprises one or more devices that may utilize sensor data to identify an object left in a vehicle and to perform actions based on identifying the left object. In some implementations, notification platforms may be modular such that certain software components may be swapped in or out depending on a particular need. As such, notification platforms may be easily and/or quickly reconfigured for different uses. In some implementations, notification platforms may receive information from and/or transmit information to one or more user devices and/or server devices.

In some implementations, as shown, the notification platform may be hosted in a cloud computing environment. Notably, while implementations described herein describe notification platform as being hosted in a cloud computing environment, in some implementations, notification platform may be non-cloud-based (i.e., may be implemented outside of a cloud computing environment) or may be partially cloud-based.

System with Multiple users: The system works on an individual level so that the user gets notified only if that specific individual has left an object behind, even if there are multiple users in the vehicle at the same time. In an embodiment, interior monitoring sensors, such as a driver monitoring camera, are employed to observe individuals entering a vehicle along with their personal belongings, which could comprise one or more objects like a briefcase, notebook, pen, glasses, or any other personal belongings. When users exit the vehicle, regardless of the number of people present, if an individual removes an object from their pocket or bag and inadvertently leaves it behind, the system can notify that individual about the forgotten object in the vehicle.

Besides just recognizing that something was left in the vehicle, by utilizing machine learning and similar techniques, the system can also specify the precise location where the object was left and identify the object itself. For instance, the system could determine that a pair of glasses was left in the side door pocket. A system could identify objects using one or more sensors and identify what that object is, based on object recognition models. Various AI models may be used to recognize the users, objects, and the association of users and the objects. The system is configured to work for one or more users simultaneously. If there are multiple users, the system detects multiple users, identifies multiple users, records and detects entry and exit of the multiple users and correlates the objects and the users.

Personal vehicle versus a rented vehicle: In an embodiment, the system identifies the vehicle details, i.e., if it is a personal vehicle or a shared vehicle like a cab. This information is used to personalize or customize the messages. Some objects, for example, like a water bottle, a wallet, eyeglasses, if left in a personal vehicle, may not need an alert, but the same objects, if left in a rented vehicle, cause inconvenience. Hence the system identifies if the vehicle is a personal vehicle or a rented vehicle via a user registration system. In an embodiment, the user registration system comprising object identification and notification is integrated with fleet registration services or interacts with fleet registration service to enable the alert. The user registration system comprises user profile which, along with personal details, trip details (past and current), payment details, etc., further comprises history on the objects and their importance score. The user can set the score for each object they usually carry along, or the system can provide some default score for the objects which the user can change through the user account. The default scores can be determined based on historical data and an aggregation of scores from a group of users based on the objects that are usually brought into the vehicle, objects that are usually left behind, objects that are collected and the time duration within which they are collected, and the objects never claimed or collected. In an embodiment, the user may be able to opt out via an interface in the registration system, after the notification, whether the user is interested in collecting the object or instructed to be discarded.

In an embodiment, anything that was brought into the vehicle by the users, particularly in a shared vehicle scenario, should also be taken when the users leave to ensure that the vehicle is left in a clean state for other users. This may not be the scenario for a personal vehicle, where for example, an empty coffee cup may be left to be discarded later and carries no inconvenience.

In an embodiment, if the person is the driver and gets in the vehicle, the driver is identified, identification of the vehicle is performed to confirm that the owner is driving a personal vehicle. Whether it is an owned vehicle, or a rented vehicle, certain objects, for example, like phone, wallet, briefcase, etc., may always get an alert. The rest of the objects like a coffee cup, water bottle, pair of glasses, etc., may not get an alert or may get an alert with low priority in no disturbance mode. In an embodiment, the system determines the current context, which comprises, vehicle type which comprises one of a ride share, a personal rental, and an owned vehicle. Further, based on the user data and the route, entry and exit points, it may also determine the context of the trip whether the user is going to the office, a party, shopping, or returning home. Based on the context of the trip, the system can determine the importance of the object. For example, when the user's destination is an office address, and is driving a personal vehicle, the system would identify that any object that is related to the office, for example a laptop, a briefcase, etc., carry high importance. Similarly, the same objects do not carry high importance when the user is returning home or taking a trip to a shopping mall on the way to the office or home. In an embodiment, the importance of the object is determined based on the context of the vehicle, and the context of the trip. In an embodiment, the alerts are given irrespective of the importance score, however, the alerts may be provided with priority score. For example, an alert for an important object like a wallet or a laptop may accompany a beep sound, a pop-up, and a vibration to grab the attention of the user immediately, whereas an alert for a water bottle may accompany a low attention grabbing message sent to the inbox without a beep or a vibration.

In one embodiment, when the person is the owner of the vehicle, then alerts may be limited to a mobile phone. In an embodiment, the system would provide an alert for objects that are visible from outside, for example, a purse that is visible from outside of the vehicle, which may cause risk of potential theft. In such cases, the vehicle may recognize that the driver has left a wallet on the dashboard and alert the user immediately. In an embodiment, for a passenger in a rideshare, based on the identification of who the owner of the object is, the system may decide the alert. In an embodiment, the alert system is based on the owner of the object.

In an embodiment, the relationship is established between the objects and the individuals based on the objects that are carried or used within the vehicle space.

The system would also maintain a profile of the person, historical data on usage of the vehicle rental service, and data on the sitting posture of the person. The system maintains the data when next time the person has entered the vehicle, the system is able to monitor the person and correlate the past data with his current trip to understand the user habits in terms of what objects, if any, the user usually forgets and sends a reminder prior to the exit of the user.

In an embodiment, the user recognition system, which may be based on face monitoring, if connected, or integrated into a third party system, or the third party systems are integrated into the user system via the object recognition and reminder system. As soon as a person gets recognized inside a vehicle, the person also is connected to all the objects that the person brings into the vehicle.

Shared scenario and collecting the objects: In an embodiment, the user gets into the vehicle, forgets an object, and gets out. The system would tag the vehicle, the user, and the object. The system may then allow the user to schedule a pickup or provide a time window with a camera-based watch and biometric authentication to collect the object safely by the user from the vehicle. The camera-based watch will ensure that the user is collecting the object or the object that belongs to him and not leaving the vehicle littered. In an embodiment, the system would lock all the other aspects in the vehicle to not let the user misuse the vehicle for any other purpose.

Unidentified objects and/or Unidentified users: Considering a scenario where a person enters the vehicle and wears sunglasses. The interior monitoring camera captures an image of this, registering the person and presence of the sunglasses. In the event the individual forgets the sunglasses while exiting the vehicle, the system alerts both the main driver or owner of the vehicle and the passenger. However, the system is also configured to handle the situation when the object is forgotten in the vehicle without the user ever interacting with the object. For example, consider the individual having a wallet in their back pocket, making it invisible to other sensors or systems at the entrance or after boarding. In such a case, the wallet might go unnoticed by the monitoring system. If the wallet drops from the back pocket of the user, unnoticed by any of the sensors until the exit, the system still determines which passenger left behind the object based on the seating position, the area around the seating position, and the user movements and gestures during the trip. In an embodiment, such an object, which cannot have 100% confidence on the correlation between the user and the object, may be correlated with a user with certain probability. In an embodiment, the information may be relayed to all the passengers boarded and exited prior to the object identification. If there are unidentified objects that are not linked to any specific individual, according to an embodiment, the information may be transmitted to all the passengers asking to identify if they lost any object and any features of the lost object. Based on the matching features with the actual lost object, a decision may be made to send more information to the correct user.

In a scenario, where the system cannot identify who brought the object inside the vehicle, can be checked via a database to find out who, at that time, rented the vehicle, because the system will still recognize that there is a person it cannot identify, but they left an object. The system may try to identify based on the exclusion of the people from the database using the timestamp of ride.

The object recognition process may occur at predefined intervals, such as every 5 minutes, every 3 minutes, every 2 minutes every 1 minute etc., ensuring continuous monitoring for objects within the vehicle. In an embodiment, monitoring is adaptive based on the number of passengers, number of objects, and the activity inside the vehicle which can be recognized using motion sensors. However, it is important to note that during this process, facial recognition may not always be successful. While an object may be detected, the system might not be able to determine the individual associated with it. In such cases, alternative methods, such as analyzing system data, may be employed to identify the person. For instance, an attempt could be made to identify the individual based on the device they brought with them.

If the object cannot be identified to who it belongs to, via facial recognition or other means, an alert is sent to all users of the vehicle prior to the object identification, that an unidentified object has been left behind. This notification serves as a reminder for individuals to check if they inadvertently left something behind. Additionally, the system can tag the object, indicating that it was found within the vehicle, but its owner could not be identified. In an embodiment, a driver of the vehicle would receive a notification informing them of the objects left behind, even if the owner of the object remains unknown. This ensures that users are aware of any objects left in the vehicle, even if their ownership cannot be determined. For instance, if someone realizes they left their wallet behind, they can inquire about it, and the system can inform the user of any unidentified objects found in the vehicle.

In an embodiment, in the event that an object is discarded or unclaimed in the vehicle, which could potentially make the interior untidy for example, it could be bits or paper, a used coffee cup, a used snack packet, a used mask, in the case of a shared context, the vehicle could pause the sharing availability and inform the service provider to clean the vehicle before it could be brought back to service. It could also inform prospective sharers that the interior space is currently waiting to be cleaned.

In an embodiment, where an occupant found an object and wondering whose it is, the system is configured such that the user could show the object to the data management system of the vehicle service provider, which in turn could notify that it has been communicated to the prospective owner or the system may recommend the users what they could do, for example to leave the object with the driver or with a lost and found center etc.

FIG. 7 shows an example block diagram for AI/ML used in object recognition and reminder system according to an embodiment. The machine learning model 772 may take as input any data associated with the sensors of the vehicle, users, user profiles, and learn to identify features within the data that are predictive of users, objects, and user-object interactions. The training data sample may comprise, for example, users and objects data 762 where images of users, images of objects in the vehicle, and images of users with objects, images of left-over objects by the users etc., in one or more vehicles. It further comprises user data such as user habits, travel frequency, objects usually carried by the users, objects most forgotten, places within the interior of the vehicle where the objects are usually forgotten, objects that are collected promptly and users are concerned about, objects that users usually are not concerned about, and objects that were never collected etc. In an embodiment, it relates to systems and methods that identify a user in real-time using an on-board camera and/or other sensors and access the user profiles. Over a period of time, various users and their user profiles may be grouped, with cybersecurity, encryption, maintaining anonymity, to learn about the patterns that relate to users, objects, interactions of users and objects, objects most forgotten, places within the interior of the vehicle where the objects are usually forgotten, objects that are collected promptly and users are concerned about, objects that users usually are not concerned about, and objects that were never collected. It may further derive patterns based on the context of a ride, such as whether the user is going to office, home, going shopping, going to meet friends, or having a stop between the rides, etc. This user identification, along with the object information, and all the above data and the output on patterns derived may be transmitted to the cloud, where the user identification is coupled with ride details and object details to predict what objects the user might likely be leaving behind or detect what objects the user is carrying. Some of the data may be historical data from the ride and the user in similar situations, as in while going to office, while meeting friends, while having certain types of conversation within the vehicle etc. Subsequently, the information is used to predict the objects that may be left behind and/or detect the objects that are left behind. The systems and methods of the present disclosure may also provide data analytics information that may be used later to improve detection accuracy, detection times, notification times etc.

The training data sample may also comprise contextual data/sensor data 764 relating to the interior of the vehicle and the environment. This may comprise, for example, sensor data on the number of the users, their seating locations, ride time of the trip, total ride time, current weather conditions, temperature, time of day, traffic conditions in the region, whether the user is in a hurry to reach a certain destination, conversations that the users are having with fellow users or on the mobile etc. For example, the system may find that the users may be more likely to forget the umbrella that they carry when it is not raining outside versus when it is raining. Similarly, the users may be more likely to forget things when they are in a hurry to reach a certain destination or when the weather at a destination location may be rainy. These are only certain examples, and the AI model may derive such patterns and more that are not very apparent to the person of ordinary skill in the art. The system may also garner contextual information from a device associated with the user. For example, through an application (App) installed on the device for object reminder and recognition system, such as an online mapping service, like Google® Maps, and location services, vehicle rental services that are integrated with the user device or the object recognition and reminder system etc. Real-time sensor data may be collected which may comprise, for example, one or more of video, image, audio, infrared, temperature, 3D modeling, and any other suitable types of data that capture the current state around the vehicle. The current contextual information may be derived from the real-time sensor data from the vehicle and the user device.

Other data 768 may comprise data derived from user data and sensor data from the vehicle. For example, social media status of the user saying they are going to a party or so and/or user conversations which can be processed via NLP to understand the context where they are in a hurry to reach a specific place due to a medical emergency in a family etc. Such data may be derived from the sensor data or user data and may be included in the other data category. Other data may comprise user habits based on historical data such as a user may usually place objects inside the pocket of the door and always forget, or the user may have the habit of forgetting his glasses, or the user may have a habit of leaving an empty coffee cup in the vehicle.

Any of the aforementioned types of data (e.g., users and objects data 762, contextual data/sensor data 764, other data 768) may correlate or form a pattern of inputs which are sensor and object data, contextual data, and other data to outputs which are recognition of objects and the corresponding confidence score (confidence score is to say accurately the object is recognized by the system), dynamic tracking of the object and recording last known position, and a prediction of objects that the user might likely be forgetting so that a closer watch can be made on the objects and the locations within the vehicle where objects, when placed, may be likely forgotten etc., and such correlation/pattern between inputs and outputs may be automatically learned by the machine learning model 772. In an embodiment, during training, the machine learning model 772 may process the training data sample (e.g., users and objects data 762, contextual data/sensor data 764, other data 768), and, based on the current parameters of the machine learning model 772, predict output 774 which may be recognition of objects and the corresponding confidence score, dynamic tracking of the object and recording last known position, a prediction of objects that the user might likely be forgetting, and the locations within the vehicle where objects, when placed, may be likely forgotten. In an embodiment, the real-time sensor data may be processed using one or more machine learning models 772, trained and based on similar types of data to correctly detect an object the user is carrying and interacting with, and a prediction of objects that the user might likely be forgetting, and the locations within the vehicle where objects, when placed, may be likely forgotten. For example, comparison 776 may be based on a loss function that measures a difference between the predicted/detected output and the training data with labels 770. Based on the comparison at 776 or the corresponding output of the loss function, a training algorithm may update the parameters of the machine learning model 772, with the objective of minimizing the differences or loss between subsequent predicted output 774 and the corresponding labels 770. By iteratively training in this manner, the machine learning model 772 may “learn” from the different training data samples and become better at predicting output 774. In an embodiment, the machine learning model 772 is trained using data which is specific to a vehicle and different users for which the model is used for predicting adjustments to the settings to provide accurate recognition of the objects and their locations and predictions. In an embodiment, the machine learning model 772 is trained using data which is general to the vehicle types and is used for predicting adjustments for prediction of objects that the user might likely be forgetting, and the locations within the vehicle where objects when placed may be likely forgotten and thus adapting the settings based on real-time data. In an embodiment, objects and the interactions may be given weights and provided as an input to the AI/ML system.

Through training, the machine learning model 772 may learn to identify predictive and non-predictive features and apply the appropriate weights to the features to optimize detecting and predictive accuracy of the machine learning model 772. In embodiments where supervised learning is used and each training data sample 758 has a label 770, the training algorithm may iteratively process each training data sample 758 (e.g., users and objects data 762, contextual data/sensor data 764, other data 768), and generate a predicted output 774 which may be recognition of objects and the corresponding confidence score, dynamic tracking of the object and recording last known position, a prediction of objects that the user might likely be forgetting, and the locations within the vehicle where objects when placed may be likely forgotten. Based on the comparison 776 results, the training algorithm may adjust machine learning model 772 parameters/configurations (e.g., weights) accordingly to minimize the differences between the generated predicted output 774 and the corresponding labels 770. Any suitable machine learning model and training algorithm may be used, including, e.g., neural networks, decision trees, clustering algorithms, and any other suitable machine learning techniques. Once trained, the machine learning model 772 may take input data and detect the objects along with their corresponding confidence score. In an embodiment, the machine learning model, 772 is an artificial neural networks (ANN) model.

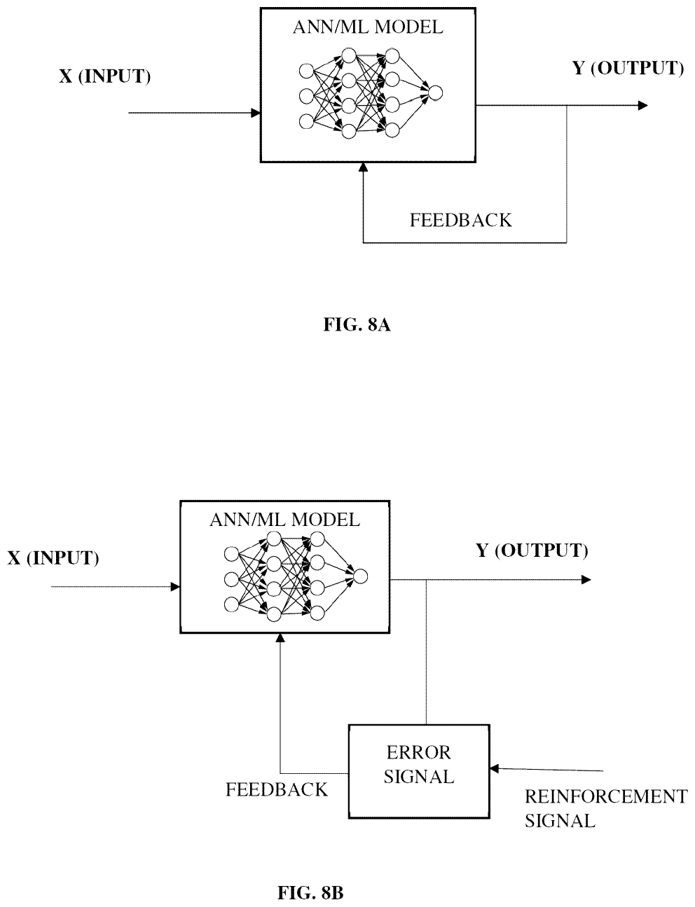

FIG. 8A shows a structure of the neural network/machine learning model with a feedback loop according to an embodiment. Artificial neural networks (ANNs) model comprises an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed to the next layer of the network. A machine learning model or an ANN model may be trained on a set of data to take a request in the form of input data, make a prediction on that input data, and then provide a response. Input data comprises users and objects data 762, contextual data/sensor data 764, other data 768, and output data may comprise recognition of objects and the corresponding confidence score, dynamic tracking of the object and recording last known position, a prediction of objects that the user might likely be forgetting, and the locations within the vehicle where objects when placed may be likely forgotten. Objects and interaction of the users with objects may carry certain weights. The model may learn from the data. Learning can be supervised learning and/or unsupervised learning and may be based on different scenarios and with different datasets. Supervised learning comprises logic using at least one of a decision tree, logistic regression, and support vector machines. Unsupervised learning comprises logic using at least one of a k-means clustering, a hierarchical clustering, a hidden Markov model, and an apriori algorithm. The output layer may be recognition of objects and the corresponding confidence score, dynamic tracking of the object and recording last known position, a prediction of objects that the user might likely be forgetting, and a prediction of the locations within the vehicle where objects when placed may be likely forgotten based on the inputs which may be users and objects data 762, contextual data/sensor data 764, other data 768.

In an embodiment, ANNs may be a Deep-Neural Network (DNN), which is a multilayer tandem neural network comprising Artificial Neural Networks (ANN), Convolution Neural Networks (CNN) and Recurrent Neural Networks (RNN) that can recognize features from inputs, do an expert review, and perform actions that require predictions, creative thinking, and analytics. In an embodiment, ANNs may be Recurrent Neural Network (RNN), which is a type of Artificial Neural Networks (ANN), which uses sequential data or time series data. Deep learning algorithms are commonly used for ordinal or temporal problems, such as language translation, Natural Language Processing (NLP), speech recognition, image recognition, etc. Like feedforward and convolutional neural networks (CNNs), recurrent neural networks utilize training data to learn. They are distinguished by their “memory” as they take information from prior input via a feedback loop to influence the current input and output. An output from the output layer in a neural network model is fed back to the model through the feedback. The variations of weights in the hidden layer(s) will be adjusted to fit the expected outputs better while training the model. This will allow the model to provide results with far fewer mistakes. The neural network is featured with the feedback loop to adjust the system output dynamically as it learns from the new data. In machine backpropagation, propagation and feedback loops are used to train an Artificial Intelligence (AI) model and continuously improve it upon usage. As the incoming data that the model receives increases, there are more opportunities for the model to learn from the data. The feedback loops, or backpropagation algorithms, identify inconsistencies and feed the corrected information back into the model as an input. Even though the AI/ML model is trained well, with large sets of labeled data and concepts, after a while the models' performance may decline while adding new, unlabeled input due to many reasons which include, but not limited to, concept drift, recall precision degradation due to drifting away from true positives, and data drift over time. A feedback loop to the model keeps the AI results accurate and ensures that the model maintains its performance and improvement, even when new unlabeled data is assimilated. A feedback loop refers to the process by which an AI model's predicted output is reused to train new versions of the model.

Initially, when the AI/ML model is trained, a few labeled samples comprising both positive and negative examples of the concepts (e.g., different types of objects, different users interacting with different objects, tracking frequency, monitoring frequency etc.) are used that are meant for the model to learn how and what adjustments needs to be performed. Afterward, the model is tested using unlabeled data. By using, for example, deep learning and neural networks, the model can then make predictions on whether the desired output (for e.g., recognition of objects and the corresponding confidence score, dynamic tracking of the object and recording last known position, a prediction of objects that the user might likely be forgetting, and the locations within the vehicle where objects when placed may be likely forgotten etc.) is in the predicted accuracy level. However, in the cases where the model returns a low probability score, this input may be sent to a controller (maybe a human moderator) which verifies and, as necessary, corrects the result. The human moderator may be used only in exceptional cases. The feedback loop feeds labeled data, auto-labeled or controller-verified, back to the model dynamically and is used as training data so that the system can improve its predictions in real-time and dynamically. These models may be utilized at various levels, for example, (i) in image processing for detecting an object based on user-object interaction images (ii) a prediction of objects that the user might likely be forgetting, and the locations within the vehicle where objects when placed may be likely forgotten and (iii) determining frequency of monitoring and frequency of dynamic tracking for improving accuracy of the output.

According to an embodiment of the method, a second set of artificial intelligence algorithms are configured to determine the frequency of monitoring of the interior region of the vehicle. According to an embodiment of the system, the system comprises a monitoring module configured for monitoring of the interior region of the vehicle. According to an embodiment of the system, the monitoring module comprises a second set of artificial intelligence algorithms. According to an embodiment of the system, a frequency of monitoring of the interior region of the vehicle is based on the second set of artificial intelligence algorithms. According to an embodiment of the system, the frequency of monitoring is based on an objective to conserve battery power of the vehicle.

FIG. 8B shows a structure of the neural network/machine learning model with reinforcement learning according to an embodiment. The network receives feedback from authorized networked environments. Though the feedback logic is similar to supervised learning, the feedback obtained in this case is evaluative, not instructive, which means there is no teacher as in supervised learning. After receiving the feedback, the network performs adjustments of the weights to get better predictions in the future. Machine learning techniques, like deep learning, allow models to take labeled training data and learn to recognize those concepts in subsequent data and images. The model may be fed with new data for testing, hence by feeding the model with data it has already predicted over, the training gets reinforced. If the machine learning model has a feedback loop, the learning is further reinforced with a reward for each true positive of the output of the system. Feedback loops ensure that AI results do not stagnate. By incorporating a feedback loop, the model output keeps improving dynamically and over usage/time.

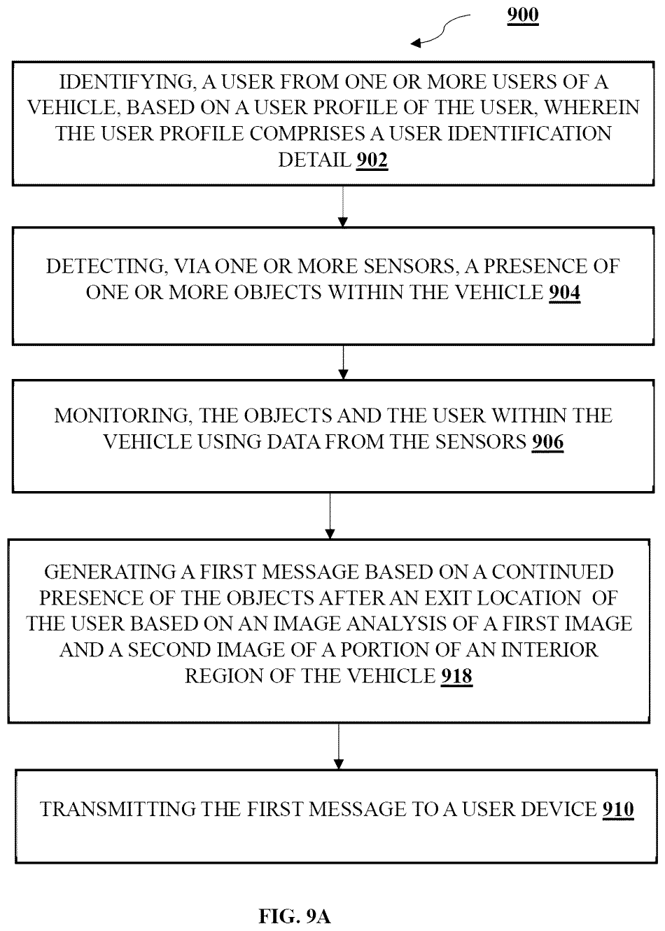

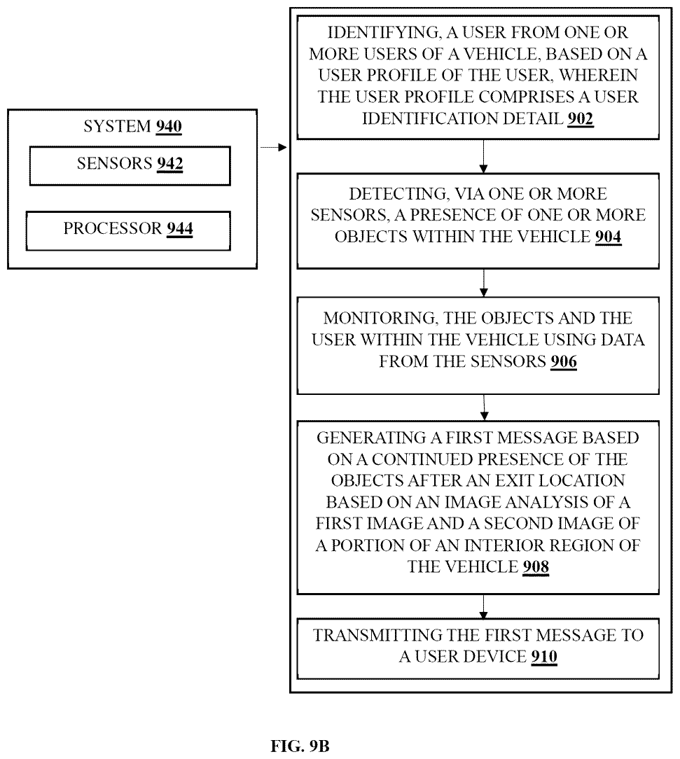

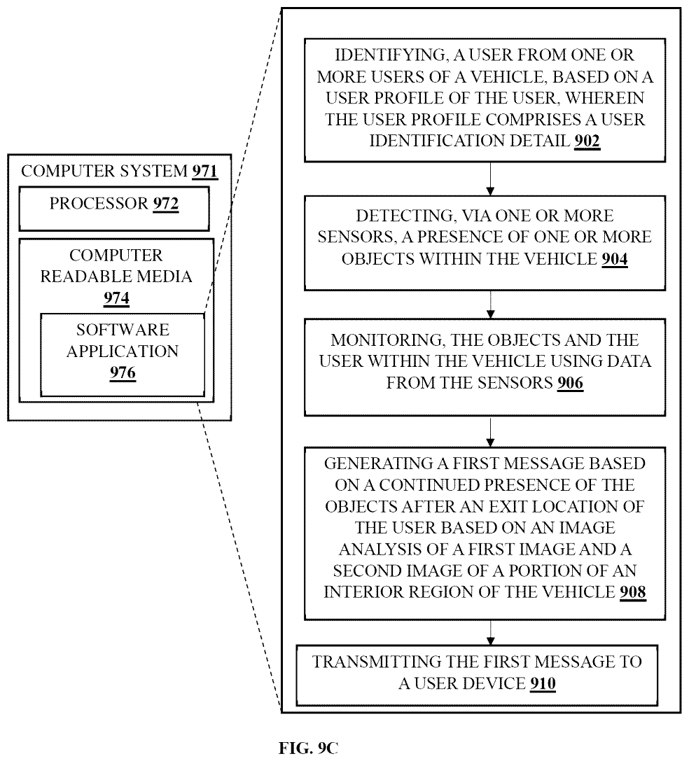

FIG. 9A shows a block diagram of the method executed by the vehicle for the object recognition and reminder system according to an embodiment. According to an embodiment, disclosed is a method 900 comprising identifying, a user from one or more users of a vehicle, based on a user profile of the user, wherein the user profile comprises a user identification detail at step 902; detecting, via one or more sensors, a presence of one or more objects within the vehicle at step 904; monitoring, the objects and the user within the vehicle using data from the sensors at step 906; generating a first message based on a continued presence of the objects after an exit location of the user based on an image analysis of a first image and a second image of a portion of an interior region of the vehicle at step 908; and transmitting the second message to a user device at step 910; and wherein the method is configured for dynamic tracking the objects within the vehicle and providing an alert notification.

According to an embodiment of the method, identification of the user is based on a biometric recognition, wherein the biometric recognition comprises one or more of an iris recognition data, a fingerprint recognition data, a facial recognition data, a voice recognition data, and a password.

According to an embodiment of the method, the objects comprises one or more of a mobile device, a handbag, a briefcase, eyeglasses, keys, water bottle, a packed food item, and a bag.

According to an embodiment of the method, the alert comprises one or more of a visual, an auditory, and a haptic alert. According to an embodiment of the method, the first message is notified to the user device of the user. According to an embodiment of the method, the first message is notified via a loudspeaker based on a proximity of the user after the exit location. According to an embodiment of the method, the first message is further notified to an alternate contact information provided in the user profile.

FIG. 9B shows a block diagram of the system of vehicle for object recognition and reminder system according to an embodiment. According to an embodiment, disclosed is a system 940 comprising one or more sensors 942; and a processor 944 storing instructions in a memory that, when executed, cause the processor 944 to identify, a user from one or more users of a vehicle, based on a user profile of the user, wherein the user profile comprises a user identification detail at step 902; detect, via the sensors, a presence of one or more objects within the vehicle at step 904; monitor, the objects and the user within the vehicle using data from the sensors at step 906; generate, a first message based on a continued presence of the objects after an exit location of the user based on an image analysis of a first image and a second image of a portion of an interior region of the vehicle at step 908; and transmit the first message to a user device at step 910; and wherein the system is configured for dynamic tracking the objects within the vehicle and providing an alert notification. According to an embodiment of the system, the vehicle takes a first image of what the car interior looks like before the user gets in, and then compares that image to a second image taken as the user gets out, to determine if anything was left behind.

According to an embodiment of the system, the user identification detail is based on a user registration system comprising a name, address, and a contact number of the user.

According to an embodiment of the system, identification of the user is based on a biometric recognition, wherein the biometric recognition comprises one or more of an iris recognition data, a fingerprint recognition data, a facial recognition data, a voice recognition data, and a password.

According to an embodiment of the system, the identity of the user is verified at an entry location of the user. According to an embodiment of the system, the objects comprises one or more of a mobile device, a handbag, a briefcase, eyeglasses, keys, water bottle, a packed food item, and a bag.

FIG. 9C shows a block diagram of the method executed by the non-transitory computer-readable medium for object recognition and reminder system according to an embodiment. According to an embodiment, disclosed is a non-transitory computer-readable medium 974 having stored thereon instructions executable by a computer system 971 to perform operations comprising identify, a user from one or more users of a vehicle, based on a user profile of the user, wherein the user profile comprises a user identification detail at step 902; detecting, via one or more sensors, a presence of one or more objects within the vehicle at step 904; monitoring, the objects and the user within the vehicle using data from the sensors at step 906; generating a first message based on a continued presence of the objects after an exit location of the user based on an image analysis of a first image and a second image of a portion of an interior region of the vehicle at step 908; and transmitting the first message to a user device at step 910; and wherein the instructions are configured for dynamic tracking the objects within the vehicle and providing an alert notification. A software application 976 may be stored on the computer-readable medium 974 and executed by a processor 972 of the computer system 971.

According to an embodiment of the non-transitory computer-readable medium, the instructions are provided to update the user profile with information about the objects, wherein the information comprises object recognition data, location of the objects, and an importance score of the objects. According to an embodiment of the non-transitory computer-readable medium, the information about the objects is changeable by the user. According to an embodiment of the non-transitory computer-readable medium, the first message is further customized based on the type of the objects and the importance score of the objects in the user profile. According to an embodiment of the non-transitory computer-readable medium, the first message comprises identity of the one or more of the objects and the location of the objects. According to an embodiment of the non-transitory computer-readable medium, the first message comprises identity of one or more of the objects and the location of the objects. According to an embodiment of the non-transitory computer-readable medium, data of a trip comprising an entry location, the exit location, list of objects carried, tracking data of the user and the objects, forgotten objects, the first message are saved to a database, wherein the database is located locally or in a cloud. In an embodiment, the first message comprises one or more of the objects and the last recorded location of the objects, and wherein the first message further comprises image of the objects.

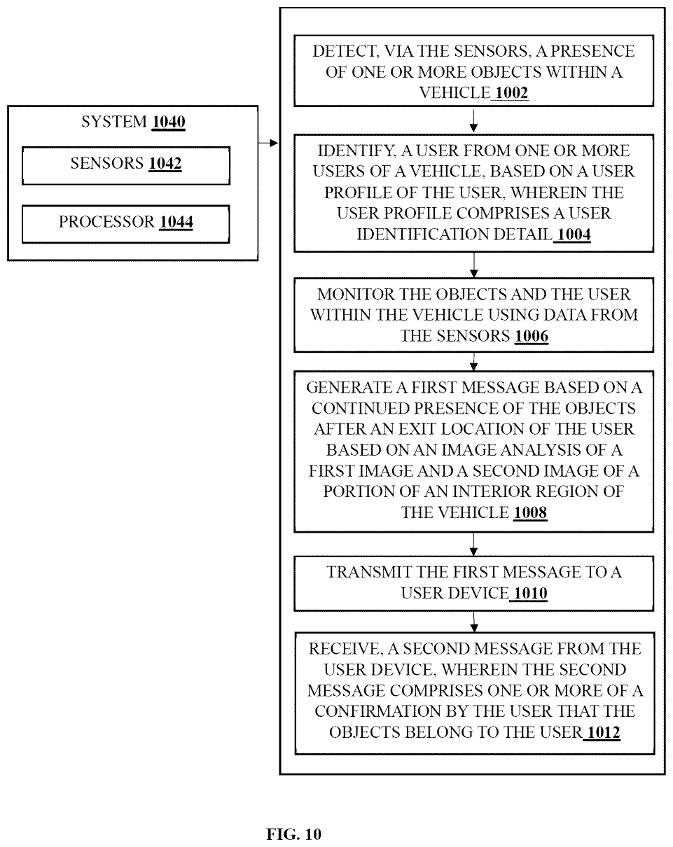

FIG. 10 shows a block diagram of the system of vehicle for object recognition and reminder system according to an embodiment. According to an embodiment, disclosed is a system 1040 comprising one or more sensors 1042; and a processor 1044 storing instructions in non-transitory memory that, when executed, cause the processor 1044 to detect, via the sensors, a presence of one or more objects within a vehicle at step 1002; identify, a user from one or more users of a vehicle based on a user profile of the user, wherein the user profile comprises a user identification detail at step 1004; monitor continuously the objects and the user within the vehicle using data from the sensors at step 1006; generate a first message based on a continued presence of the objects after an exit location based on an image analysis of a first image and a second image of a portion of an interior region of the vehicle at step 1008; and transmit the first message to a user device at step 1010; and receive, a second message from the user device at step 1012, wherein the second message comprises one or more of a confirmation by the user that the objects belong to the user.

According to an embodiment, the user device may be integrated in the vehicle. In an embodiment, the message may be sent to a device inside of the vehicle, that is to the driver. The user device could be internal, such as a built-in infotainment unit, driver device or external, such as a smartphone of the user.

According to an embodiment of the system, identification of the user is based on a biometric recognition, wherein the biometric recognition comprises one or more of an iris recognition data, a fingerprint recognition data, a facial recognition data, a voice recognition data, and a password. According to an embodiment of the system, the user profile further comprises one or more of a past trip data, a current trip data comprising entry location, the exit location, a list of objects with corresponding importance, an emergency contact detail, one or more alternate contact details of the user, a home address of the user, and an office address of the user.

According to an embodiment of the system, the sensors are positioned strategically at one or more locations within the vehicle based on a configuration of the vehicle, for visualization and tracking of movements of the user and the objects.

According to an embodiment of the system, the system further comprises an object recognition module comprising object recognition algorithms and a first set of artificial intelligence algorithms configured to analyze data from the sensors and determine one or more of the presence of the objects, recognize the objects; and a location of the objects within the vehicle. According to an embodiment of the system, the object recognition module comprises the sensors and further comprises an RGB-IR camera, a driver monitoring system, a first cabin monitoring system placed in a front region, a second cabin monitoring system placed in a rear region on roof configured for a 2D detection. According to an embodiment of the system, the object recognition module further comprises one or more radars strategically placed above a side window for 3D detection. According to an embodiment of the system, an input comprising a 3D model and one or more images of the interior region of the vehicle in different light conditions is provided to the first set of artificial intelligence algorithms. According to an embodiment of the system, the first set of artificial intelligence algorithms are trained to match type of the objects and map the location of the objects within a space of the interior region of the vehicle; and wherein the first set of artificial intelligence algorithms are trained to identify the objects as at least one of a living entity and a non-living entity.

According to an embodiment of the system, the processor is configured to receive one or more images from the sensors and the objects are recognized based on one or more of object detection parameters comprising one or more attributes of the objects, wherein the attributes comprises a shape, a color, a size, a texture, a trip context, a material, a feature, a pattern, a depth, a unique identification tag, and an RFID tag.

According to an embodiment of the system, the system comprises a monitoring module comprising a second set of artificial intelligence algorithms configured for continuous monitoring of the interior region of the vehicle. According to an embodiment of the system, a frequency of monitoring of the interior region of the vehicle is based on the second set of artificial intelligence algorithms and are configured to conserve battery power of the vehicle. According to an embodiment, the frequency of monitoring is based on remaining energy in the battery.

According to an embodiment of the system, the first image of the interior region of the vehicle is taken before the user enters the vehicle and the second image of the interior region of the vehicle is taken after the user exits the vehicle. According to an embodiment of the system, an alert is provided via one or more of a visual, an auditory, and a haptic feedback. According to an embodiment of the system, the first message comprises one or more of the objects, the location of the objects, and an image of the objects. According to an embodiment of the system, the system is configured to interact with an application software on a mobile device. According to an embodiment of the system, the second message comprises a request location and a time to collect the objects.

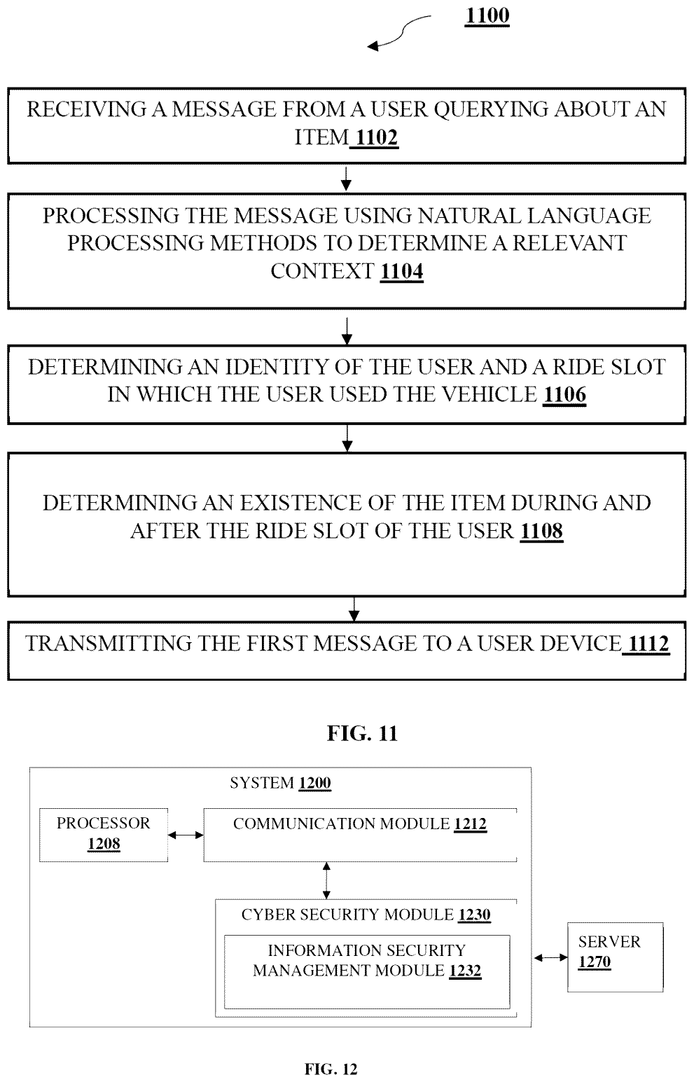

FIG. 11 shows a block diagram of the method executed by the vehicle for object recognition and reminder system according to an embodiment. According to an embodiment, disclosed is a method 1100 comprising, receiving a message from a user querying about an object at step 1102; processing the message using natural language processing methods to determine a relevant context at step 1104; determining an identity of the user and a ride slot in which the user used the vehicle at step 1106; determining an existence of the object during and after the ride slot of the user at step 1108; and transmitting the first message to a user device at step 1112.

FIG. 12 shows the block diagram of the cyber security module 1230 in view of the system and server according to an embodiment. The communication of data between the processor 1208 of system 1200 and the server 1270 through the communication module 1212 is first verified by the information security management module 1232 before being transmitted from the system to the server or from the server to the system. Cyber security module 1230 comprises information security management module 1232. The information security management module is operable to analyze the data for potential cyber security threats, to encrypt the data when no cyber security threat is detected, and to transmit the data encrypted to the system or the server. In an embodiment, the cyber security module further comprises an information security management module providing isolation between the system and the server. In an embodiment, the system comprises methods for securing the data through the cyber security module. The information security management module is operable to receive data from the communication module, exchange a security key at the start of the communication between the communication module and the server, receive a security key from the server, authenticate an identity of the server by verifying the security key, analyze the security key for potential cyber security threats, negotiate an encryption key between the communication module and the server, receive the encrypted data, transmit the encrypted data to the server when no cyber security threat is detected. In an embodiment, the system comprises decryption of data by the cyber security module according to an embodiment. In an embodiment, the system comprises methods for securing the data through the cyber security module. The information security management module is operable to receive data from the communication module, exchange a security key at a start of the communication between the communication module and the server, receive a security key from the server, authenticate an identity of the server by verifying the security key, analyze the security key for potential cyber security threats, negotiate an encryption key between the communication module and the server, receive encrypted data, decrypt the encrypted data, and perform an integrity check of the decrypted data, transmit the decrypted data to the communication module when no cyber security threat is detected.

In an embodiment, the integrity check is a hash-signature verification using a Secure Hash Algorithm 256 (SHA256) or a similar method. In an embodiment, the information security management module is configured to perform asynchronous authentication and validation of the communication between the communication module and the server. In an embodiment, the information security management module is configured to raise an alarm if a cyber security threat is detected. In an embodiment, the information security management module is configured to discard the encrypted data received if the integrity check of the encrypted data fails. In an embodiment, the information security management module is configured to check the integrity of the decrypted data by checking accuracy, consistency, and any possible data loss during the communication through the communication module. In an embodiment, the server is physically isolated from the system through the information security management module. When the system communicates with the server as shown in FIG. 12, identity authentication is first carried out on the system and the server. The system is responsible for communicating/exchanging a public key of the system and a signature of the public key with the server. The public key of the system and the signature of the public key are sent to the information security management module. The information security management module decrypts the signature and verifies whether the decrypted public key is consistent with the received original public key or not. If the decrypted public key is verified, the identity authentication is passed. Similarly, the system and the server carry out identity authentication on the information security management module. After the identity authentication is passed on to the information security management module, the two communication parties, the system, and the server, negotiate an encryption key and an integrity check key for data communication of the two communication parties through the authenticated asymmetric key. A session ID number is transmitted in the identity authentication process, so that the key needs to be bound with the session ID number; when the system sends data to the outside, the information security gateway receives the data through the communication module, performs integrity authentication on the data, then encrypts the data through a negotiated secret key, and finally transmits the data to the server through the communication module. When the information security management module receives data through the communication module, the data is decrypted first, integrity verification is carried out on the data after decryption, and if verification is passed, the data is sent out through the communication module; otherwise, the data is discarded.

In an embodiment, the identity authentication is realized by adopting an asymmetric key with a signature. In an embodiment, the signature is realized by a pair of asymmetric keys which are trusted by the information security management module and the system, wherein the private key is used for signing the identities of the two communication parties, and the public key is used for verifying that the identities of the two communication parties are signed. Signing identity comprises a public and a private key pair. In other words, signing identity is referred to as the common name of the certificates which are installed in the user's machine. In an embodiment, both communication parties need to authenticate their own identities through a pair of asymmetric keys, and a task in charge of communication with the information security management module of the system is identified by a unique pair of asymmetric keys. In an embodiment, the dynamic negotiation key is encrypted by adopting an Rivest-Shamir-Adleman (RSA) encryption algorithm. RSA is a public-key cryptosystem that is widely used for secure data transmission. The negotiated keys include a data encryption key and a data integrity check key.

In an embodiment, the data encryption method is a Triple Data Encryption Algorithm (3DES) encryption algorithm. The integrity check algorithm is a Hash-based Message Authentication Code (HMAC-MD5-128) algorithm. When data is output, the integrity check calculation is carried out on the data, the calculated Message Authentication Code (MAC) value is added with the header of the value data message, then the data (including the MAC of the header) is encrypted by using a 3DES algorithm, the header information of a security layer is added after the data is encrypted, and then the data is sent to the next layer for processing. In an embodiment the next layer refers to a transport layer in the Transmission Control Protocol/Internet Protocol (TCP/IP) model. The information security management module ensures the safety, reliability, and confidentiality of the communication between the system and the server through the identity authentication when the communication between the two communication parties starts the data encryption and the data integrity authentication. The method is particularly suitable for an embedded platform which has less resources and is not connected with a Public Key Infrastructure (PKI) system and can ensure that the safety of the data on the server cannot be compromised by a hacker attack under the condition of the Internet by ensuring the safety and reliability of the communication between the system and the server.

The descriptions of the one or more embodiments are for purposes of illustration but are not exhaustive or limiting to the embodiments described herein. Many modifications and variations will be apparent to those of ordinary skill in the art without departing from the scope and spirit of the described embodiments. The terminology used herein best explains the principles of the embodiments, the practical application and/or technical improvement over technologies found in the marketplace, and/or to enable others of ordinary skill in the art to understand the embodiments described herein.

1-108. (canceled)

109. A system comprising:
one or more sensors; and
a processor storing instructions in non-transitory memory that, when executed, cause the processor to:
identify, a user from one or more users of a vehicle, based on a user profile of the user, wherein the user profile comprises a user identification detail;
detect, via the sensors, a presence of one or more objects within the vehicle;
monitor, the objects and the user within the vehicle using data from the sensors;
generate, a first message based on a continued presence of the objects after an exit location of the user based on an image analysis of a first image and a second image of a portion of an interior region of the vehicle; and
transmit the first message to a user device; and
wherein the system is configured for dynamic tracking the objects within the vehicle and providing an alert notification.

110. The system of claim 109, wherein the user identification detail is based on a user registration system comprising a contact number of the user, and wherein identification of the user is based on a biometric recognition, wherein the biometric recognition comprises a facial recognition.

111. The system of claim 109, wherein the sensors comprise one or more of camera-based sensors, radar, lidar, a microphone, an infrared sensor, a biometric sensor, a gesture recognition sensors, an optical sensor, an ultrasonic sensor, a laser sensor, a weight sensor, a pressure sensor, a motion sensor, a touch sensor, a seat sensor, a door sensor.

112. The system of claim 109, wherein the sensors are located at one or more doors of the vehicle and are configured to identify one or more of an entry and an exit of the user; and wherein a seat sensor is configured to determine a seating position of the user.

113. The system of claim 109, wherein the system further comprises an object recognition module comprising object recognition algorithms and a first set of artificial intelligence algorithms configured to analyze data from the sensors and determine one or more of the presence of the objects, recognize the objects and the location of the objects within the vehicle, wherein recognizing the objects comprises classifying the objects and providing a label; and wherein the objects comprises one or more of a mobile device, a handbag, a briefcase, eyeglasses, keys, water bottle, a packed food item, and a bag.

114. The system of claim 113, wherein the object recognition module comprises the sensors and further comprises an RGB-IR camera, a driver monitoring system, a first cabin monitoring system placed in a front region, a second cabin monitoring system placed in a rear region on roof configured for a 2D detection, and one or more radars strategically placed above a side window of the vehicle for 3D detection.

115. The system of claim 113, wherein the first set of artificial intelligence algorithms are trained to match type of the objects and map the location of the objects within a space of the interior region of the vehicle, and wherein the first set of artificial intelligence algorithms are trained to identify the objects as at least one of a living entity and a non-living entity.

116. The system of claim 109, wherein the system correlates the objects detected with the user profile based on proximity and a movement pattern of the user and the objects, and further maintains an association between the user and the objects using the dynamic tracking; and wherein the system is configured to adaptively refine the association between the user and the objects based on user interaction with other users using the dynamic tracking in real-time.

117. The system of claim 109, wherein the dynamic tracking generates a trajectory and a location of the objects, wherein the location is tagged with the objects.

118. The system of claim 109, wherein the first image of the interior region of the vehicle is taken before the user enters the vehicle and the second image of the interior region of the vehicle is taken after the user exits the vehicle.

119. The system of claim 109, wherein the system further comprises an alert generation module, configured to notify the user about the objects, and wherein the alert generation module is configured to provide the alert notification via one or more of a visual, an auditory, and a haptic feedback.

120. The system of claim 109, wherein the first message is notified to the user device of the user; and wherein the first message comprises one or more of the identity of the objects, image of the objects, and the last recorded location of the objects.

121. The system of claim 109, wherein the first message is further notified to an alternate contact information provided in the user profile; and wherein the first message is customized further based on a type of the vehicle, wherein the type of the vehicle is one of a rental, a personal hire, and an owned.

122. A method comprising:
identifying, a user from one or more users of a vehicle, based on a user profile of the user, wherein the user profile comprises a user identification detail;
detecting, via one or more sensors, a presence of one or more objects within the vehicle;
monitoring, the objects and the user within the vehicle using data from the sensors;
generating a first message based on a continued presence of the objects after an exit location of the user based on an image analysis of a first image and a second image of a portion of an interior region of the vehicle; and
transmitting the first message to a user device; and
wherein the method is configured for dynamic tracking the objects within the vehicle and providing an alert notification.

123. The method of claim 122, wherein the method is configured to determine a frequency of monitoring of the interior region of the vehicle using a second set of artificial intelligence algorithms; and wherein the frequency of monitoring is determined based on a battery power of the vehicle.

124. The method of claim 122, wherein the first image of the interior region of the vehicle is taken before the user enters the vehicle and the second image of the interior region of the vehicle is taken after the user exits the vehicle; and wherein a third image is taken comprising the user at least one of at an entry location and outside the vehicle using external sensors and immediately after the user enters using the sensors; and wherein the third image is used to identify the objects that are associated with the user.

125. The method of claim 122, wherein the method correlates the objects detected with the user profile based on proximity and a movement pattern, and further maintains an association between the user and the objects using the dynamic tracking in real-time; and further configured to adaptively refine the association between the user and the objects based on user interaction with other users using the dynamic tracking in real-time; and wherein the dynamic tracking generates a trajectory and a location of the objects, wherein the location is tagged with the objects.

126. The method of claim 122, wherein the objects are classified as connected to the user when the user interacts with the objects; and wherein the objects are classified as positioned when the user places the objects with no interaction; and wherein the objects are tagged as hidden when the objects are out of sight to any of the sensors once the objects are detected.

127. A non-transitory computer-readable medium having stored thereon instructions executable by a computer system to perform operations comprising:
identify, a user from one or more users of a vehicle, based on a user profile of the user, wherein the user profile comprises a user identification detail;
detecting, via one or more sensors, a presence of one or more objects within the vehicle;
monitoring, the objects and the user within the vehicle using data from the sensors;
generating a first message based on a continued presence of the objects after an exit location of the user based on an image analysis of a first image and a second image of a portion of an interior region of the vehicle; and
transmitting the first message to a user device; and
wherein the instructions are configured for dynamic tracking the objects within the vehicle and providing an alert notification.

128. The non-transitory computer-readable medium of claim 127, wherein data of a trip comprising an entry location, the exit location, list of objects carried, tracking data of the users and the objects, forgotten objects, the first message, are saved to a database, wherein the database is located locally or in a cloud.
